(19) United States
(12) Patent Application Publication
(10) Pub. No.: US 2013/0191140 A1
(43) Pub. Date: Jul. 25, 2013

(54) CAREGIVER PROCESSES AND SYSTEMS

(71) Applicants: Joshua Robert Fotheringham, Highlands Ranch, CO (US); James Hoyt Jarman, Brea, CA (US); David Smith Howell, Brea, CA (US)

(72) Inventors: Joshua Robert Fotheringham, Highlands Ranch, CO (US); James Hoyt Jarman, Brea, CA (US); David Smith Howell, Brea, CA (US)

(73) Assignee: Caring in Place Inc., Highlands Ranch, CO (US)

(21) Appl. No.: 13/460,189

(22) Filed: Apr. 30, 2012

Related U.S. Application Data
(63) Continuation-in-part of application No. 13/248,535, filed on Sep. 29, 2011.
(60) Provisional application No. 61/387,917, filed on Sep. 29, 2010.

(51) Int. Cl. G06Q 10/06; G06Q 50/22

(52) U.S. Cl. CPC G06Q 10/063114; G06Q 50/22
USPC 705/2

(57) ABSTRACT

Embodiments of the invention relate to methods and systems for coordinating care for a care recipient among one or more caregivers. Caregivers can organize and assign tasks related to a diagnosis, illness, condition, behavior, living condition, etc. of a care recipient. Interactive systems and methods are disclosed that allow multiple caregivers to accomplish a plurality of tasks, generate care related reports, and/or monitor medication compliance.

### CROSS-REFERENCES TO RELATED APPLICATIONS

This is a continuation-in-part and claims the benefit of co-pending, commonly assigned U.S. patent application Ser. No. 13/248,535, filed Sep. 29, 2011, entitled “Medical Facility Management System,” which is a non-provisional application of and claims the benefit of commonly assigned U.S. Provisional Application No. 61/387,917, filed on Sep. 29, 2010, entitled “Medical Facility Management System,” the entirety of each of these applications are herein incorporated by reference for all purposes.

### SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

Embodiments of the invention are directed toward a system for coordinating care for a care recipient by one or more caregivers. The system can include one or more caregiver devices that are each used by an individual caregiver and a care server communicatively coupled with the one or more caregiver devices in use by a caregiver. The care server can generate one or more care related tasks for a care recipient, assign each of the one or more tasks to individual caregivers, and communicate the tasks to the caregivers via the caregiver device.

Embodiments of the invention can also include a method that aids caregivers in caring for a care recipient. The method can include receiving data from a caregiver via a caregiver device indicating a medication dosage for a care recipient. Reminders can be pushed to one or more caregivers through the caregiver device reminding the caregiver to check on the care recipient's adherence to the medication dosage. Input from a caregiver can be received indicating dates, times and amounts of medication taken by the care recipient. And a medication adherence measure can be determined based on the medication dosage and on the input indicating dates, times and amounts of medication taken.

### BRIEF DESCRIPTION OF THE FIGURES

Illustrative embodiments of the present invention are described in detail below with reference to the following drawing figures.

FIG. 1 shows a high-level view of caregiver system 100 according to some embodiments of the invention.

FIG. 2 shows data structures that can be used in care server 105 according to some embodiments of the invention.

FIG. 3 shows a flowchart of a process for beginning a careplan according to some embodiments of the invention.

FIG. 4 shows a flowchart of a process for inputting and setting up a careplan for a care recipient according to some embodiments of the invention.

FIG. 5 shows a flowchart of a process for inputting and setting up a task from a primary caregiver according to some embodiments of the invention.

FIG. 6 shows a flowchart of a process that occurs when a task is completed according to some embodiments of the invention.

FIG. 7 shows a flowchart of a process for offering care-related services and/or products according to some embodiments of the invention.

FIG. 8 shows a flowchart of a process for rating a task according to some embodiments of the invention.

FIG. 9 shows a flowchart of a process for recommending prioritized tasks according to some embodiments of the invention.

FIG. 10 shows a simplified block diagram of a computer system 1000 that can be used in the various embodiments of the invention.

FIGS. 11-45 show screen shots representing various embodiments of the invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Systems and methods are disclosed that provide a network of tasks, activities, data streams, services, products, data sources, aides, etc. for use by caregiver(s) in caring for a care recipient according to some embodiments of the invention. Often a care recipient is an aging loved one that is cared for at home by untrained caregivers. A caregiver can include a parent, relative, friend, or neighbor; and may include a third party or hired caregiver that participates in the care. The system and methods can provide a number of tools to a caregiver. For example, it may allow multiple caregivers to coordinate care and/or communicate about the type of care that is needed for a care recipient. It may also allow care related tasks to be assigned and checked off. The disclosed system and/or methods may also use data retrieved from care related devices used (or not used) by the care recipient to coordinate care. Various reports, updates, streams, tasks, notes, tasks, communication, coordination, etc. related to care can be implemented.

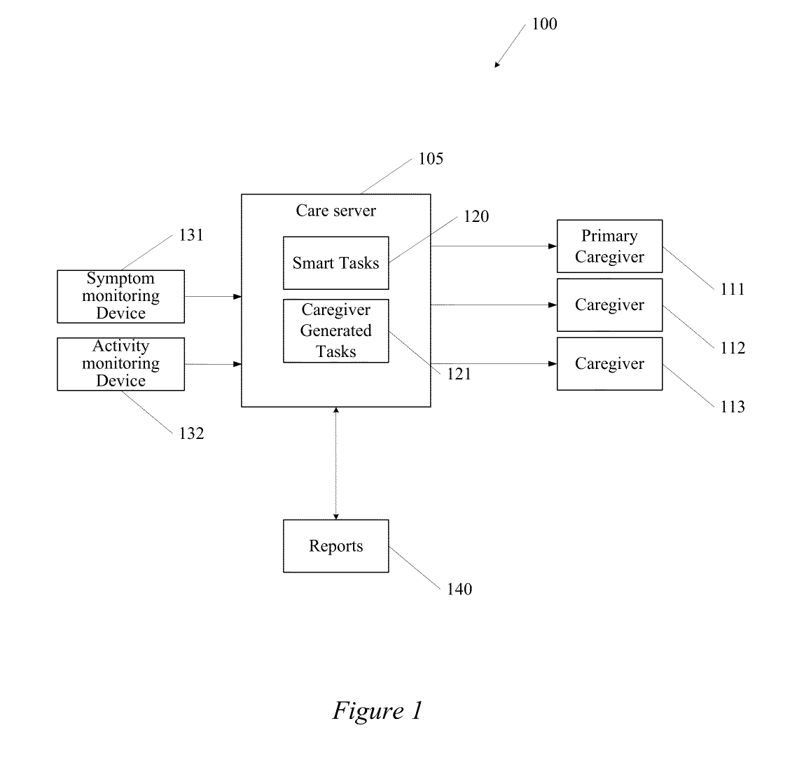

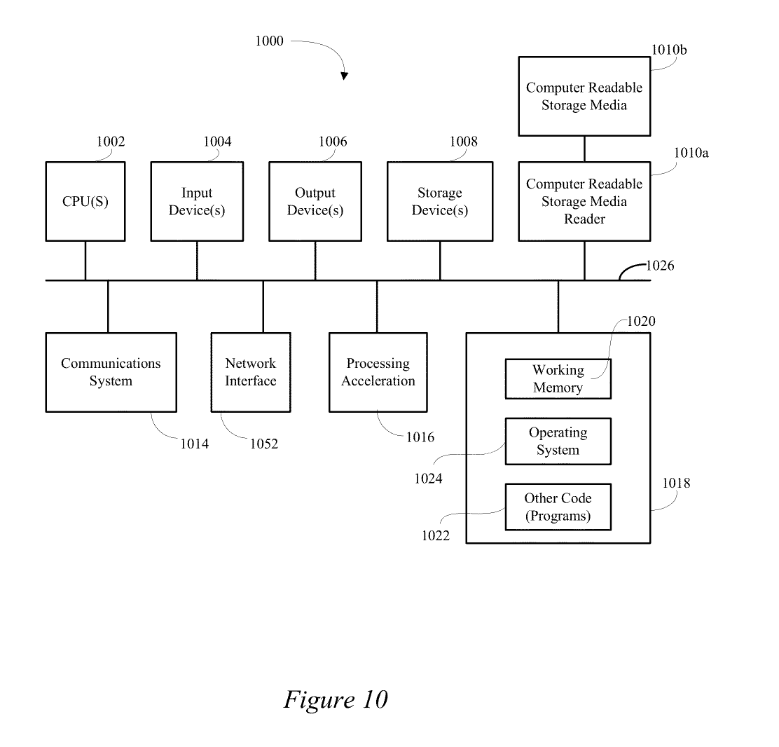

The system and methods can be implemented in an integrated technology solution. FIG. 1 shows a high-level view of caregiver system 100 according to some embodiments of the invention. Caregiver system 100 can include care server 105. Care server 105 can be implemented on a computer system (e.g., computer system 1000 shown in FIG. 10) and can include a database that includes data, tasks, notes, tasks, activities, data devices, caregivers, etc. Care server 105 can be distributed among many computers, servers, and/or devices and can be accessed using various computing devices (e.g., computer system 1000 shown in FIG. 10). For example, care server 105 can include tasks that organize what caregivers should be doing to care for a care recipient and the various related tasks associated with the task can be pushed to individual user's devices.

Tasks can include, for example, smart task 120 that is automatically generated based on information about the care recipient. For instance, smart task 120 can include the tasks to be performed by a caregiver based on the care recipient's diagnosis, ailment, condition, symptoms, medication, behaviors, etc. For example, when a care recipient is diagnosed with diabetes a smart task can be automatically generated with tasks associated with diabetes such as check to make sure blood sugar levels are regularly checked and/or check on insulin supplies. As another example, when a care recipient is prescribed blood thinning medication, a smart task may be automatically generated to check on the care recipient's administration of the proscribed dosage and/or to check on symptoms that are indicative of known side effects of the medication. A smart task can also be created based on data provided by symptom monitoring device 131. For example, when symptom monitoring device 131 inputs data that a care recipient's weight has dropped below a certain threshold value (or percentage), a task can be created to have a caregiver check on the care recipient.

For example, care server 105 can also include caregiver tasks 121. Caregiver tasks 121 can include tasks that are not generic to specific conditions, diagnosis, ailment, medications, symptoms, or behaviors. Caregiver tasks 121, for example, can be created for any reason. For example, a caregiver may design a task around the living arrangements, the dietary preferences, personality, or symptoms unrelated to a smart task. Caregiver tasks 121 can include tasks related to conditions, medications, symptoms, behaviors, etc. that are not associated with a smart task. As another example, caregiver tasks 121 can include doctor (or medical staff) generated tasks.

While many tasks are described herein with reference to examples of embodiments of the invention, any number or type of task can be implemented without limitation. Tasks can be created for any reason. Moreover, the term “task” is synonymous with the term “activity” when used in the context of caring for a care recipient.

Care server 105 can also receive input from devices such as symptom monitoring device 131 and/or activity monitoring device 132. These devices can provide data regarding various care activities. For example, data devices can provide data related to symptoms or activities. As another example, data devices can provide data related to surroundings, environment, health status, location, etc. For example, symptom monitoring device 131 can provide data related to blood-glucose levels, blood pressure, heart rate, temperature, cholesterol level, weight, etc. of a care recipient. Various other symptoms can be monitored and data provided by symptom monitoring device 131.

Activity monitoring device 132 can provide, for example, information regarding the administration of medication, information showing movement in a home, for example, movement to or from specific rooms or past specific points; GPS devices providing information about movement of a care recipient; cupboard/refrigerator opening and closing detectors providing information about kitchen usage; vertical and/or horizontal positioning to determine whether the care recipient has fallen; alarm snooze; environment data such as temperature of the home; video data of the care recipient or their environment; food levels in cupboards, refrigerators, shelves, or drawers; etc. Various other activities can be monitored by activity monitoring device 132.

Symptom monitoring device 131 and/or activity device 13 can transmit data to care server 105 using a wired or wireless network. The devices can transmit data noting the completion of a task, provide information that a task should be accomplished, and/or provide information about a care recipient that can be stored in a database.

Care server 105 can be communicatively coupled with caregiver devices 111, 112, and 113, which include an interface linking a plurality of caregivers with care server 105. Care server 105 can provide information about tasks to care givers and/or receive information from a care giver regarding the completion of a task. Care givers can be associated with individual care giver interfaces. These care interfaces can be implemented via a web interface, an application that runs on a computer, or an app on a smart phone or tablet. Tasks, information, requests, and/or data can be pushed from care server 105 to caregivers. Some tasks and/or data can be pushed to individual care givers and/or to all care givers.

Care server 105 can also record data received from monitoring devices 131 and 132 and from caregiver devices 111, 112, and 113. While three care givers are shown, any number may be implemented. Moreover, caregiver devices 111, 112, and 113 can use any type of web based or mobile computing device. For example, mobile computing devices can include various portable computing devices such as iPhones, iPads, smartphones, Android phones, tablets, netbooks, PDAs, televisions, etc. Applications, web portals, web pages, apps can be used by the caregiver.

Data received from caregiver devices 111, 112, and/or 113 and/or monitoring devices 131 and/or 132 can be stored in a database. Various reports 140 can be generated from this data. These reports can be arranged to show symptom trends, activity trends, care trends, etc. Reports can be printed in hard copy or electronically transferred to a caregiver or to medical personnel.

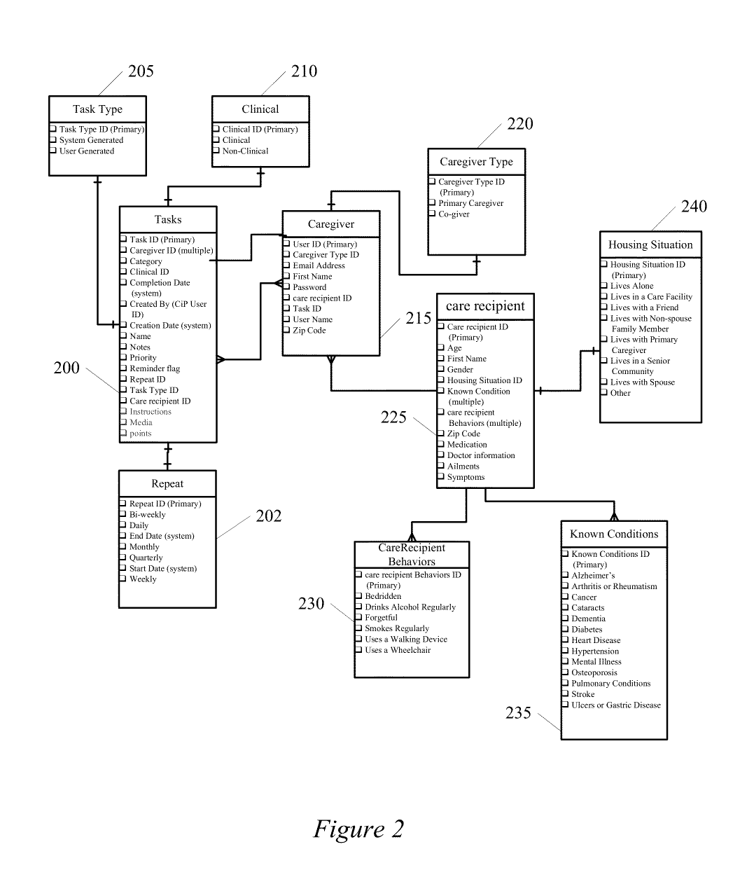

FIG. 2 shows data structures that can be used in care server 105 according to some embodiments of the invention. While the data structure shown in FIG. 2 is designed around Task structure 200, these data structures can be designed around other components. Each data elements shown related to each structure may or may not be present in a structure. Moreover, additional data elements may be used and implemented into a data structure. Task structure 200 can include a task identifier that uniquely identifies the task. Task structure 200 can also be associated with one or more caregiver identifiers that identify the caregiver(s) associated with Task structure 200.

Task structure 200 can also include a category identifier that can be used to categorizing tasks based on different groupings. For example, tasks could be categorized as must get done, critical, minor, etc. Or, tasks could include user defined categories; for example, home care, medical or clinical care, personal, private, etc. Users could also be assigned to all the tasks in a category or be invited to accept task in a specific category only.

Task structure 200 can also include a clinical ID 210 that identifies the task as clinical or non-clinical. Clinical tasks, for example, my require a higher priority than other tasks and/or the non-completion of a clinical task may trigger a different response than a non-clinical task.

Clinical ID 210 can also be a flag that can indicate that a specific task be included in a clinical report. In this way clinicians will be provided relevant or requested data and not all the data.

Task structure 200 can also include the date and/or time the task was created and/or completed. Task structure 200 can also include the ID of the caregiver that created and/or completed the task. Task structure 200 can also include a task name, task notes, task priority relative to other tasks, a reminder flag, a repeat ID, and/or task ID 205 that identifies the task as system or user generated.

Repeat ID structure 202 can include an identifier that can be used to relate the repeat ID structure with a task and/or can include how often the task is repeated and/or the start and end of the repeating task. For instance, a task can be repeated daily, weekly, bi-weekly, monthly, multiple times a day, quarterly, etc. Tasks that are repeated can be pushed to the care givers as noted in the Repeat ID starting on the start date and ending on the end date.

Each caregiver structure 215 can include a caregiver ID that uniquely identifies the caregiver. Multiple caregivers can be associated with a single task. And multiple tasks can be associated with a single caregiver. For each task, caregiver structure 215 can have a caregiver type structure 220 that specifies whether the caregiver is a primary caregiver or co-caregiver. Caregiver structure 215 can include the caregiver's name, the caregiver's email address, the caregiver's telephone number, the caregiver's password, the care recipient ID, task ID, the caregiver's username, the caregiver's zip code, etc.

Each care recipient structure 225 can include a care recipient ID, name, age, gender, and/or zip code of the care recipient. A care recipient structure 225 can also include a housing situation ID associated with housing situation ID 240, known condition ID associated with known condition structure 235, and/or patient behaviors ID associated with behavior structure 230. Care recipient structure 225 can also include information about medication being taken by the care recipient.

Behavior structure 230 can include an identifier that can be used to relate the behavior structure with a care recipient and/or may identify a specific behavior associated with a care recipient. The behavior structure can behaviors such as bedridden, forgetful, addiction issues, physical aides, etc.

Known condition structure 235 can include a known condition identifier that can be used to relate the known condition structure with a care recipient. Any condition can be identified, for example, conditions such as Alzheimer's, Arthritis, rheumatism, cancer, cataracts, dementia, diabetes, heart disease, hypertension, mental illness, osteoporosis, pulmonary condition, stroke, ulcers, etc.

Housing situation structure 240 can include a housing situation identifier that can be used to relate a housing situation structure with a care recipient. The housing situation structure can identify a care recipient as living alone, living in a care facility, living with a friend, living with a family member, living with a primary caregiver, living with a spouse, living in a senior community, and/or living in another situation.

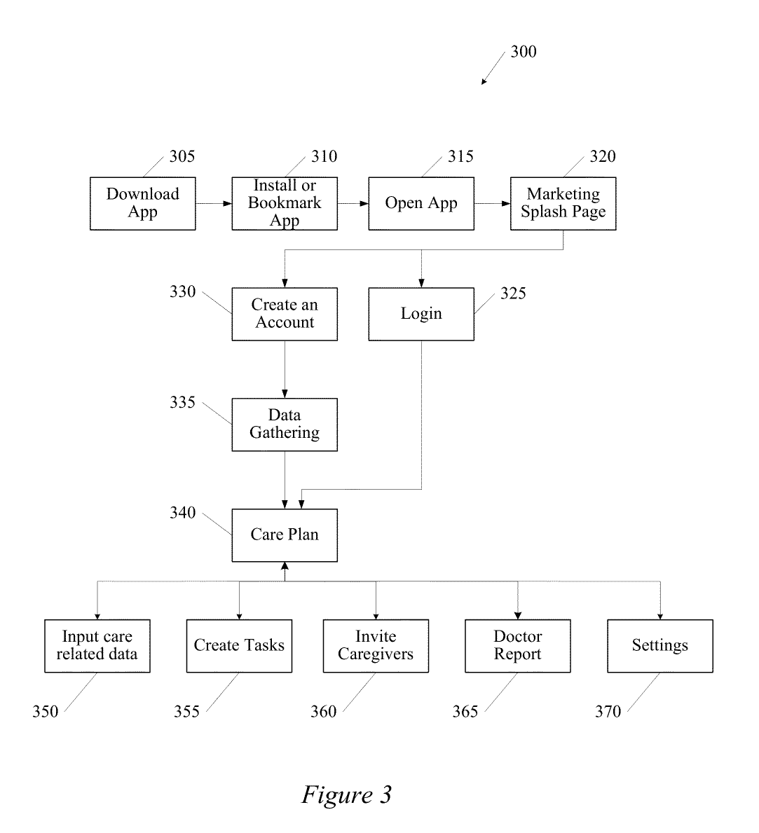

FIG. 3 shows a flowchart of process 300 for beginning a careplan according to some embodiments of the invention. Process 300 begins at block 305 when a user downloads a app or application from an online store or initiates a careplan through a web browser. A user can be any person associated with the care recipient; for example, a son, daughter, sibling, friend, neighbor, doctor, etc.

At block 310 the application or app is installed on the user's device or the web page associated with the careplan is bookmarked in the web browser application.

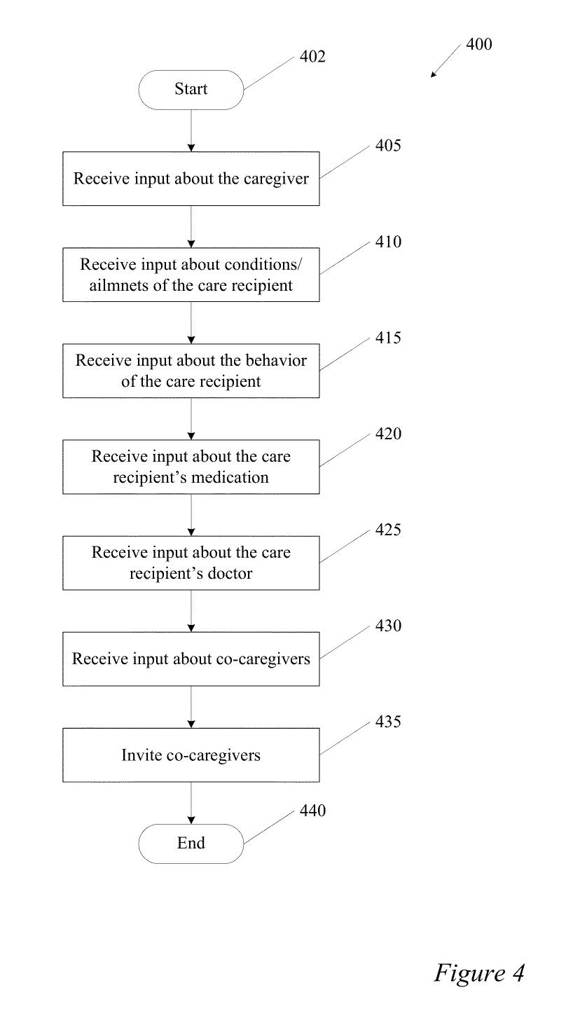

At block 315 the application is opened through a web page running on a web browser, through an application on a computer, or through an app on mobile device. At block 320 a marketing page can be displayed. If the user is a returning user with a previously created account, the user can log in at block 325. If not, the user can create an account at block 330. Any number of answers to questions may be required to create an account and such data is gathered at block 335 and sent to the care system. This data can include personal data about the user or data about the potential care recipient. In particular, the data may include data required to initiate a careplan for a new care recipient as outlined in FIG. 4.

At block 340 the user can access the careplan maintained by the care system for one or more care recipients. Access to the careplan may include any number of processes that help the user care for a care recipient including those described herein. Moreover, access to the careplan can occur by sending and/or receiving messages from the app, application or web portal used by the caregiver to and/or from the care system. In some embodiments, the care system can regularly update information stored on the caregiver's device by pushing data to the caregiver's device so that the device is updated when the caregiver uses the device.

The user can input data to the care plan 340. The data received from the user can be entered through an application, app or web portal and sent to the care system in a message. The data can then be pushed from the care plan 340 to user devices or accounts (and/or vice versa) so other users can access such data. Moreover, data received from other care givers can be pushed to the caregivers.

Various specific tasks can be performed by the user. For example, the user can create care related tasks at block 355. At block 360 the user can invite additional care givers and/or assign tasks to care givers. At block 365 the user can generate and/or view a doctor report prepared by the care system that includes data received and/or generate by the care system. At block 370 the user can update and/or modify user setting within the care system.

The various blocks shown in process 300 can occur in any order. Moreover, blocks can be skipped and/or other blocks may be added without limitation.

FIG. 4 shows a flowchart of process 400 for inputting and setting up a careplan for a care recipient according to some embodiments of the invention. Process 400 starts at block 402. At block 405 data about a caregiver are input from a caregiver. Often, when a careplan is set up it is set up by a primary caregiver. The primary caregiver can first input data about themselves into the careplan such as the data associated with caregiver structure 215. The data can be input from the caregiver using a web interface or an app on a smartphone and/or tablet. The data can be sent to the care system in an electronic message.

At block 410 information about ailments or condition of the care recipient can be input into the care system. This information can be information related to care recipient structure 225. This information can include any diagnosed diseases, viruses, conditions, ailments, or sicknesses that inflict the care recipient.

At block 415 information about the behaviors of the care recipient can be input to the care system. For example, a caregiver can select behavior from a dropdown menu or enter behaviors in a text field. These behaviors can be sent to the care plan as part of an electronic message. At block 420, information about any medication taken by a care recipient can be input to the care system. For example, a caregiver can select medication from a dropdown menu or enter medication in a text field. The medications can be sent to the care plan as part of an electronic message. This information can include the type of medication, the medication dosage, the prescription amount, the prescription expiration date, etc.

At block 425 the care system can receive information about a care recipient's doctor. At block 430 co-caregivers can be assigned to assist in the care of the care recipient. This input can include the data elements shown in caregiver structure 215.

The co-caregivers can be sent an invitation to participate in the care of the care recipient at block 435. The invention can be sent via email or text. Moreover, the invention can include information about the care recipient and/or specific care tasks that are requested of the co-caregiver. The co-caregiver(s) can accept the invitation and participate in the care of the care recipient by receiving and completing care related tasks. Process 400 can end at block 440.

The various blocks shown in process 400 can occur in any order. Moreover, blocks can be skipped and/or other blocks may be added without limitation.

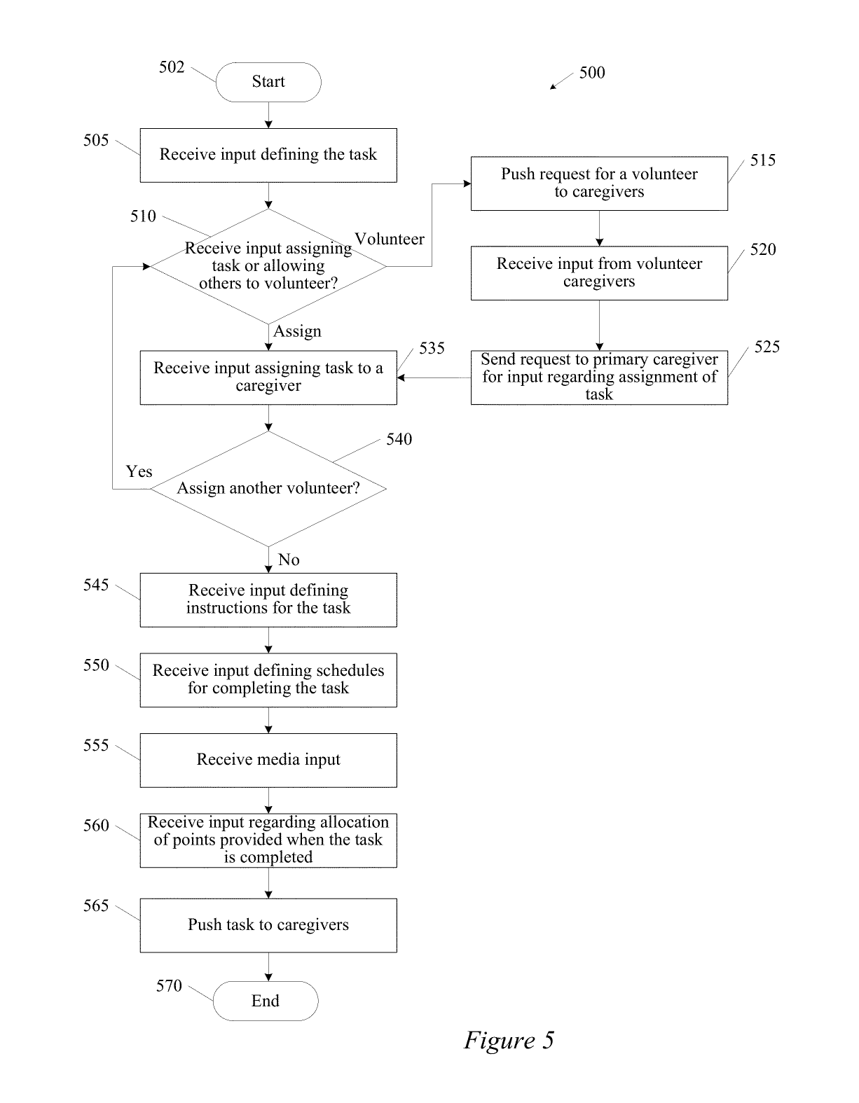

FIG. 5 shows a flowchart of process 500 for inputting and setting up a task (e.g., caregiver tasks 121) from a primary caregiver according to some embodiments of the invention. Process 500 starts at block 502. At block 505 the primary caregiver can enter information regarding a new task. The information can be input into a web browser, application or app from a caregiver. The information can define the task and/or can include some or all the data elements found in task structure 200. The task can be associated with a specific care recipient using the care recipient ID. In some embodiments the primary care giver can be presented with text entry fields, radio buttons, pull down menu's etc. to aide in receiving data about the task. The data entered by the primary care giver can be sent to the care system. In response, for example, the care system can create a task with an associated task ID and/or various other elements of the task structure.

The primary caregiver creating the task can choose to assign the task to a specific co-caregiver or allow other caregivers to volunteer for the task. To do so, for example, the primary caregiver can be presented with a question sent from the care system requesting such information. In response to the question, at block 510, the care system can receive input assigning task or allowing others to volunteer.

If the primary caregiver chooses to request volunteers, at block 515 a request message for a volunteer can be pushed to all caregivers associated with a care recipient. The request can include, for example, a button to select or push that will return a response to the careplan showing a willingness to accept the task. For example, the care system can determine the associated care recipients by looking up the various care recipient IDs associated with the care recipient ID. Various care givers can volunteer for the task by so indicating at block 520. At some later time, the primary caregiver can receive a listing showing all the caregivers that have volunteered for the task at block 525. At block 535 the primary caregiver can assign the task to specific caregiver. In some situations, a single volunteer may have volunteered for the task. In such situations, the primary care giver simply assigns the task to that caregiver. In other situations no caregivers volunteer for the task. The primary caregiver may then assign themselves or assign the task to a caregiver at block 535. The care system can push a message to the caregivers that the request for volunteers is no longer pending. In some embodiments, this message can include instructions to remove the message requesting volunteers so that the caregivers can no longer respond to the request.

In some embodiments, a task may remain unassigned and care givers may be able to review all the unassigned tasks may be viewable by all the caregivers. In this way a caregiver may perform an unassigned task and mark it as complete without being assigned the task. In some embodiments, caregivers can swap assigned tasks

At block 540 the care system can send a message to the primary care giver asking the primary caregiver if they'd like to assign another caregiver to the task. If so, process 500 can return to block 510. Otherwise, process 500 proceeds to block 545.

In some embodiments, a task may not be assigned to a caregiver. For instance, the task may be crated and pushed to all caregivers. Any caregiver can complete the task. Moreover, in some embodiments, the task can be assigned to a caregiver after the task has been created; for example, after block 560.

At block 545, the primary caregiver can enter instructions and a message can be sent to the care system with the received instructions. The care system can save this information with task data structure. These instructions can be task specific. The instructions can be as simple as stop by and visit with the care recipient, check the care recipient's medication, check to see if the care recipient has food for the coming days or week, check on the status of monitoring devices, etc. The number and type of task and/or instructions can vary depending on the care recipient's needs, behaviors, and/or conditions.

At block 550, the primary caregiver can define schedules for completing the task and a message can be sent to the care system with the received schedule. The schedule can include dates, repeating dates, times, deadlines, etc. The care system can save this information with the task data structure. At block 555 media related to the completion of the task can be recorded and/or uploaded to the care system. This media, for example, can include a video showing how to complete the task. As another example, the media can include a photograph showing where to look for specific items that may be integral to the completion of the task. The media can be created by the primary caregiver (e.g., using the primary caregiver's smart phone) and/or uploaded from another source. The media may include a link to a specific web location where the media is stored. The care system can associate the media or a link to the media with the task.

At block 560 the primary caregiver can assign points that may be allocated to co-caregivers upon completion of the task. Points can be awarded to caregivers upon the completion of a task. Points can be redeemed for various prizes. Various other information and/or data can be entered by the primary caregiver and added to the task structure by the care system. When all the requested data has been entered by the primary caregiver, the task may be pushed to caregivers at block 565.

Process 500 can end at block 570. The various blocks shown in process 500 can occur in any order. Moreover, blocks can be skipped and/or other blocks may be added without limitation.

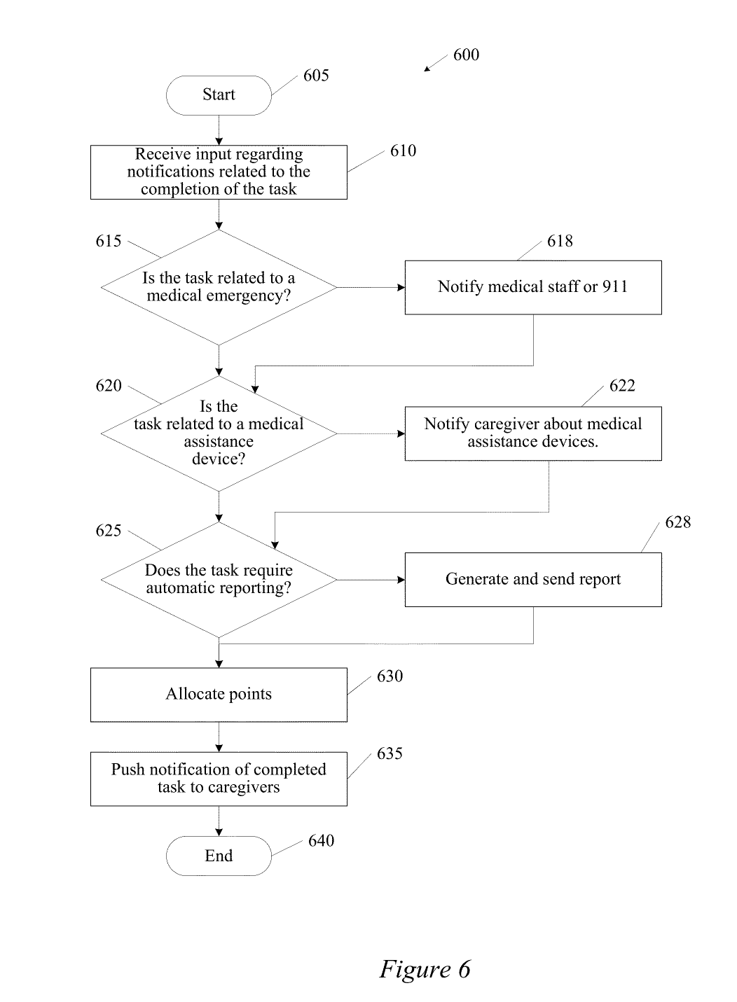

FIG. 6 shows a flowchart of process 600 that occurs when a task is completed according to some embodiments of the invention. Process 600 can start at block 605. At some point in time a task may be completed by a caregiver (e.g., the assigned caregiver). After completing the task, for example, the caregiver can indicate completion of the task through the care system web portal, on their application or app. In response to this interaction, a message can be sent to the care system at block 610 that indicates completion of the task. The message can include, for example, the task ID, task name, caregiver ID, caregiver name, notes, date, time, location, etc. The message can also include data about the care recipient. For example, the caregiver can select the task in a listing of tasks and click on a task completed button. In response, the message can be sent to the care system. In some embodiments, the caregiver can provide notes on the completion of the task that may be included in the message indicating that the task has been completed. The notes can also include media taken by the caregiver about the care recipient; for example, photographs of bed sources, videos of the care recipient's condition, audio of the care recipient coughing, etc.

At block 615, the care system can determine whether the data is associated with a medical emergency. If it is, then a message can be sent to the medical staff and/or a call can be placed to emergency personal at block 618. For example, if the task requires the caregiver to test the blood pressure of the care recipient, then the caregiver may input the care recipient's blood pressure measurement and have it sent to the care system. If the pressure is below or above a first threshold, then medical staff can be notified through an email, pager, phone, or fax. If the pressure is below or above a second threshold, then emergency personal can be notified via an email, pager, phone, or fax. For example, an automated call can be placed to 911 or a call can be instigated by third party. As another example, the user can be notified to call the medical staff or emergency personal if the data is associated with a medical emergency. Various other medical emergencies can trigger block 618.

At block 620, process 600 can determine if the task is related to a medical assistance device. If it is, then the caregiver can be notified about a medical assistance device that can be used to complete future tasks at block 622. For example, if the task requires that the caregiver take the blood pressure of the care recipient, then the user can be notified about devices that can be used by the care recipient to take their own blood pressure and have the data sent to the care system. As another example, if the task requires that the caregiver take the temperature of the care recipient, then the user can be notified about devices that can be used by the care recipient to take their own temperature and have the data sent to the care system. As yet another example, devices can be associated with heart rate, weight, movement, blood sugar levels, toilet frequency, medication dispensers, ailment threshold monitoring devices (e.g, devices that pose questions that care recipients or care givers can respond to that can aide in determining ailment levels), location devices, nutrition monitoring devices, physical exercise monitoring device, eyesight devices, fat content monitoring devices, etc. Any of these devices can be specific use devices or general purpose devices programed for a specific purpose (e.g., a smart phone with a specific application). Any device can also monitor or provide data about multiple symptoms, conditions, or ailments. Moreover, care givers can be notified about services or devices that can aide in household chores, household maintenance, etc.

At block 625, process 600 determines whether the task requires automatic reporting. If it does, then a report can get sent to the primary caregiver, a caregiver, and/or medical staff at block 628. The reports may vary depending on the task, patient, and/or who the report is being sent to.

At block 630 points can be allocated to the caregiver providing the care if points are being used. At block 635, a notification that the task has been completed is pushed to other caregivers. Process 600 can end at block 640. The various blocks shown in process 600 can occur in any order. Moreover, blocks can be skipped and/or other blocks may be added without limitation.

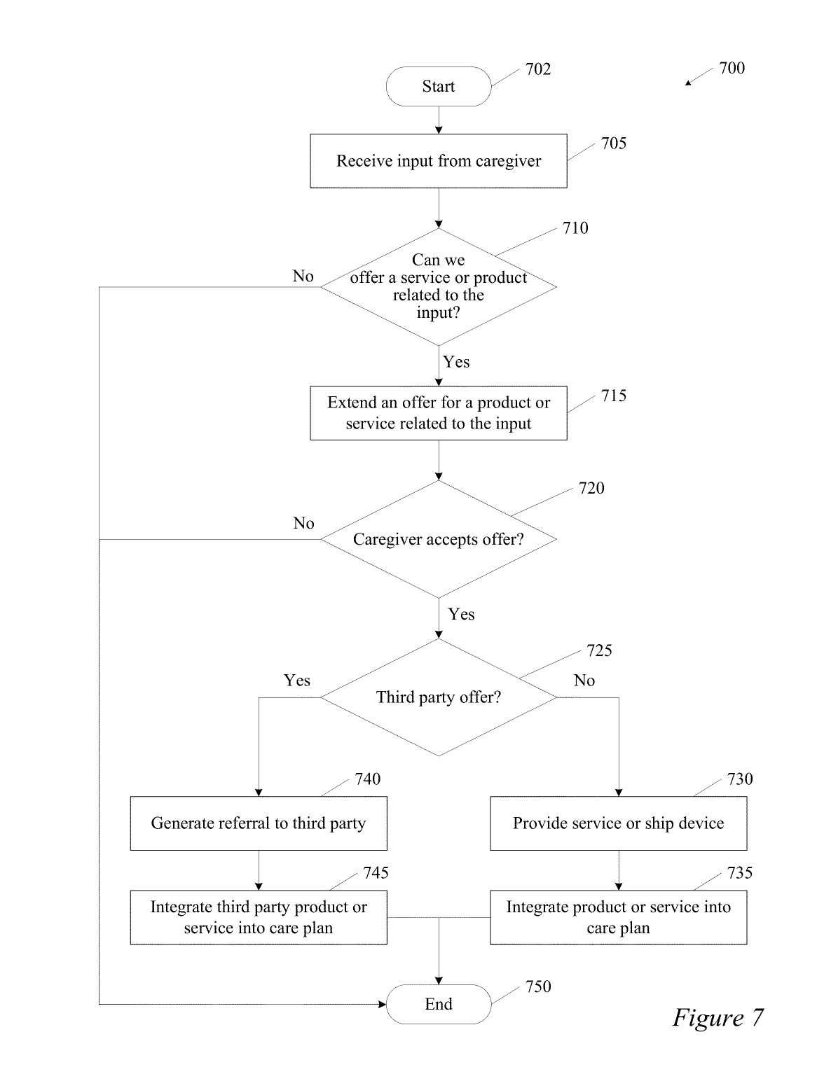

FIG. 7 shows a flowchart of process 700 for offering care-related services and/or products according to some embodiments of the invention. Process 700 starts at block 702. At block 705 an input can be received from a caregiver regarding caring for the care recipient. At block 710, it can be determined whether the received input is related a product or service can be offered. For example, if the caregiver enters data regarding the blood pressure of the care recipient, then the caregiver can be notified about devices that can be used by the care recipient to take their own blood pressure and have the data sent to the care system. As another example, if the caregiver enters data regarding the temperature of the care recipient, then the user can be notified about devices that can be used by the care recipient to take their own temperature and have the data sent to the care system. As yet another example, devices can be associated with heart rate, weight, movement, blood sugar levels, toilet frequency, etc. And as another example, devices can be associated with medication reminders, care recipient movement, therapy, exercises, bed sore rotation reminders, and oxygen refill reminders, etc. These devices can include other devices listed elsewhere in this specification or devices that monitor other ailments and/or conditions specified elsewhere in this specification. Other services can include maid services, assisted living services, housekeeping services, yard work services, drug delivery services, etc. And

At block 715 an offer for a related service or product can be extended to the caregiver. For example, if the caregiver entered an input that they just raked the leaves in the care recipient's yard, then, at block 715, the caregiver can be offered a yard maintenance service for the care recipient. The offer can be extend to the caregiver through a web portal, application, or app.

As another example, if the caregiver entered an input that they just checked that the caregiver had taken their required medication, then then the caregiver can be offered to purchase a device that dispenses, monitors, and/or keeps a record of medication. In some embodiments, when a caregiver repeatedly performs the same or similar tasks, the system can offered services or products only when the first task has been completed, when every N (a number that may depend on the service) tasks has been completed, or after a certain number of days has passed between offerings. Any number or type of services or products may be offered in response to receiving a message that a task has been completed.

At block 720, the caregiver can accept or deny the offer. If they deny the offer, then process 700 proceeds to block 750. If the caregiver accepts the offer, then it is determined whether the offer was a third party offer at block 725. If the product or service is not from a third party, then the service is provided and/or the product is shipped at block 730 and at some time the product or service is integrated into the care system at block 735. If the product or service is from a third party, then a referral is generated and sent to the third party at block 740, and at some time the product or service is integrated into the careplan at block 745. Then process 700 can end at block 750. The various blocks shown in process 700 can occur in any order. Moreover, blocks can be skipped and/or other blocks may be added without limitation.

In some situations, the integration of the product or service into the careplan may not occur for some time. For instance, it may be integrated into the plan after the product or service has been shipped, delivered, or when the service provider is ready to provide the service.

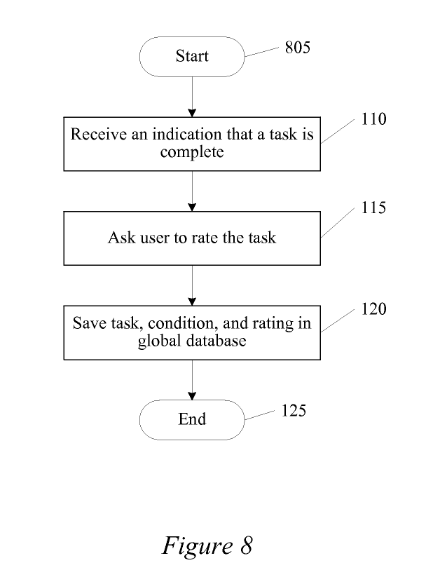

FIG. 8 shows a flowchart of process 800 for rating a task according to some embodiments of the invention. Process 800 can start at block 805. At block 810 an indication can be received by the care server that a caregiver has completed a task. At block 815, the caregiver can be asked to rate the task. For some repetitive tasks, for example, the caregiver may not be asked to rate the task after every completion. Instead, the caregiver can be asked to rate the task after a set number of repetitions of the task. As another example, the caregiver can rate the task after completion of a series of related tasks. As yet another example, the caregiver can rate the task after every task. As yet a further example, the caregiver can be asked to rate a task at certain evaluation points such as after a doctor visit.

The caregiver can rate the task based on any number of factors that may or may not depend on the condition, behaviors, etc. of the care recipient. These factors can include, for example, ease of completing the task, the time it took to complete the task, the value of the task in relation to the overall care of the care recipient, the value of the task from the perspective of the care recipient, etc. These ratings along with the task and conditions and/or behaviors can be saved in a global database without any connection or independent from the caregiver or care recipient information. That is, the ratings, conditions, behaviors, and tasks can be saved in the database without any personal information related to the caregiver. At some point the database can be collated and tasks can be scored based on user rating. Process 800 can end at block 825. The various blocks shown in process 800 can occur in any order. Moreover, blocks can be skipped and/or other blocks may be added without limitation.

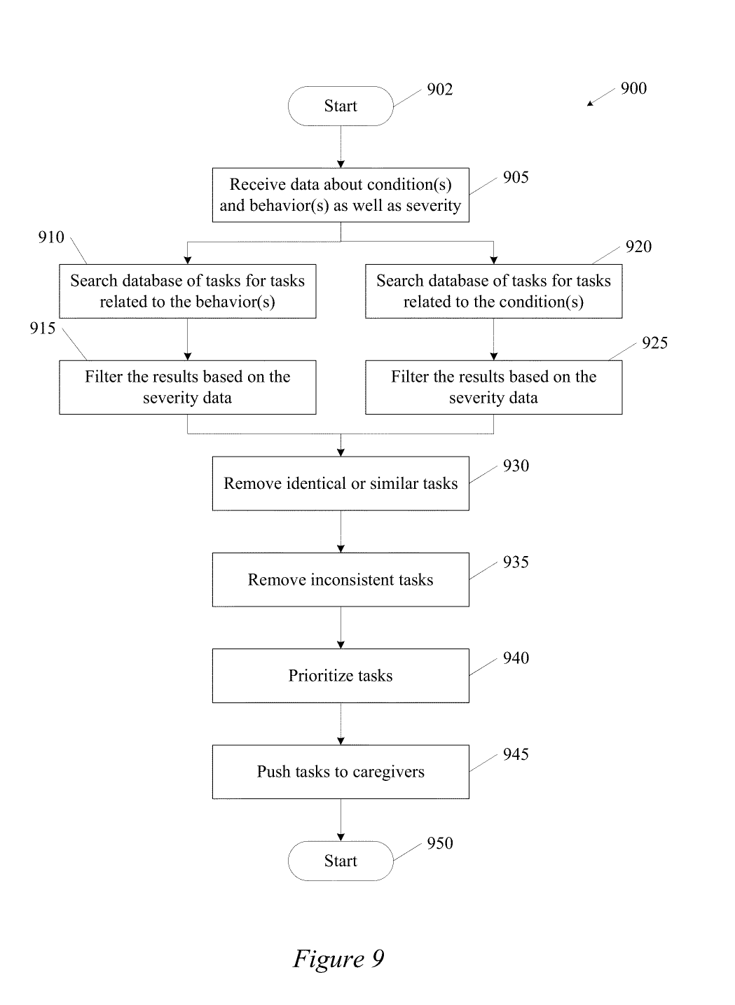

FIG. 9 shows a flowchart of process 900 for recommending prioritized tasks according to some embodiments of the invention. Process 900 begins at 902. At block 905 data regarding conditions and/or behaviors as well as the severity of each. The conditions can include, for example, ailments, diagnosis, diseases, etc. Behaviors can include, for example, mobility, living conditions, abilities, etc. The severity of both the conditions and/or behaviors can also be received. The severity can also include the type or degree of a condition or behavior. For example, the severity can include the type of diabetes, the severity of dementia, the severity of cancer, the degree of mobility, etc. This data can be received, for example, when a care giver inputs care recipient information.

At block 910 a database of tasks linked to behaviors can be searched based on the behaviors received at block 905. The tasks in the database can be previously input into the system by other caregivers caring for a care recipient with the same behaviors. The tasks can be created by the system provider in conjunction with input from medical professionals. The tasks can also be created or recommended by health and/or medical associations. The returned tasks can then be filtered based on the severity of the behavior of the care recipient at block 915.

At block 920 a database of tasks linked to conditions can be searched based on the conditions received at block 905. The tasks in the database can be previously input into the system by other caregivers caring for a care recipient with the same conditions. The tasks can be created by the system provider in conjunction with input from medical professionals. The tasks can also be created or recommended by health and/or medical associations. The returned tasks can then be filtered based on the severity of the condition ailing the care recipient at block 925.

As an example, a care giver enters information describing a care recipient with a type

B diabetic condition and a mild dementia behavior. The condition is diabetes with the severity (or type) as type B. The behavior is dementia with the severity as mild. The care server searches a task database for tasks related to diabetes and dementia. The returned tasks are sorted based on type B diabetes and mild severity of dementia.

Blocks 910 and 920 can be processed in parallel or one after another. A set of tasks can be returned from each process. At block 930 identical or similar tasks can be removed. For example, if both the condition and behavior return task to help the care recipient exercise, one of these tasks can be removed from the set of tasks. At block 935 inconsistent tasks can be removed. For example, if the condition returns the task of taking the care recipient for a walk yet the behavior indicates that the care recipient is immobile, then this task can be removed by the care system.

At block 940 the returned tasks can be prioritized based on a number of factors. These factors can include, for example, caregiver ratings, care recipient ratings, health organization ratings, doctor ratings, etc. Moreover, some tasks may include a required indication that can be used to boost the task to the top of the priority list. A required rating can be indicated based on medical professional and/or health or medical association recommendation.

At block 945 a set of these tasks can be pushed to the caregiver. For example, a message can be sent to the caregiver indicating that suggested tasks are being sent with a listing of the top 3, 5, 7, 9, 10, 12, 15, etc. tasks for the caregiver to consider. Process 900 can then end at block 950. The caregiver can implement the tasks presented by the care system.

The various blocks shown in process 900 can occur in any order. Moreover, blocks can be skipped and/or other blocks may be added without limitation.

FIG. 10 shows a simplified block diagram of a computer system 1000 that can be used in the various embodiments of the invention. Computer system 1000 can be used to perform any or all the steps shown in FIGS. 3-9. Computer system 1000 can also be used with or without all its components in any of the blocks of FIG. 1 (e.g., database, reporting engine, admin web portal, family web portal, iPhone, etc.).

The drawing illustrates how individual system elements can be implemented in a separated or more integrated manner. The computer system 1000 is shown having hardware elements that are electrically coupled via bus 1026. Network interface 1052 can communicatively couple the computer system 1000 with another computer, for example, through a network such as the Internet. The network interface can be used with caregiver devices 111, 112, 113; the care server 105; and/or monitoring devices 131, 132 shown in FIG. 1. The hardware elements can include a processor 1002, input device 1004, output device 1006, storage device 1008, computer-readable storage media reader 1010a, communications system 1014, processing acceleration unit 1016 such as a DSP or special-purpose processor, and memory 1018. The computer-readable storage media reader 1010a can be further connected to a computer-readable storage medium 1010b, the combination comprehensively representing remote, local, fixed, and/or removable storage devices plus storage media for temporarily and/or more permanently containing computer-readable information.

Computer system 1000 can maintain various databases that can be used to store caregiver data, care recipient data, tasks related to conditions and/or behaviors, etc. Users can access the data through various user interfaces such as web portals, smart phones, etc.

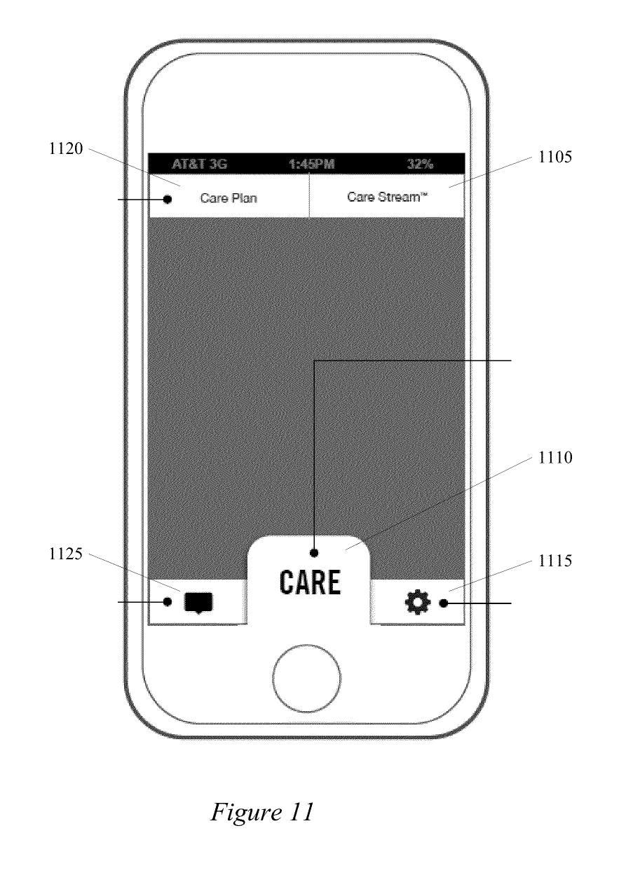

FIGS. 11-44 shows screen shots of various functions of a caring in place app on a caregiver's device. This device can correspond with caregiver devices 111, 112, and 113 as shown in FIG. 1. These screen shots may be modified and/or configured to include or remove functionality disclosed and/or may be implemented on other devices with different user interfaces without limitation.

FIG. 11 shows an example of a home screen for a caring in place app. Five buttons are shown. Button 1105 changes the caregiver interface to the care stream, which shows what has been accomplished. Button 1120 changes the caregiver interface to view the careplan. Button 1110 changes the caregiver interface to work with tasks. For example, by selecting this button the user interface will allow the caregiver to begin a task, mark a task, completed, ask help from someone in the network, or learn more about a task. Button 1115 allows the caregiver to modify settings. For example, the caregiver may be able to switch between care recipients, careplans, and change care preferences such as push notifications, auto notifications, and other settings. Button 1125 changes the user interface to allow the caregiver to add or update the careplan.

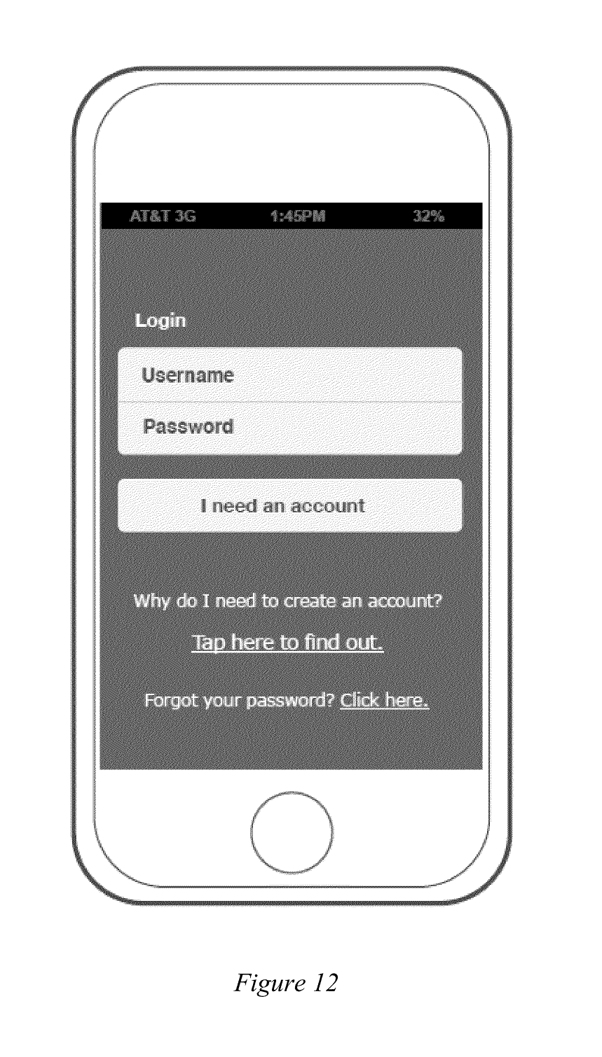

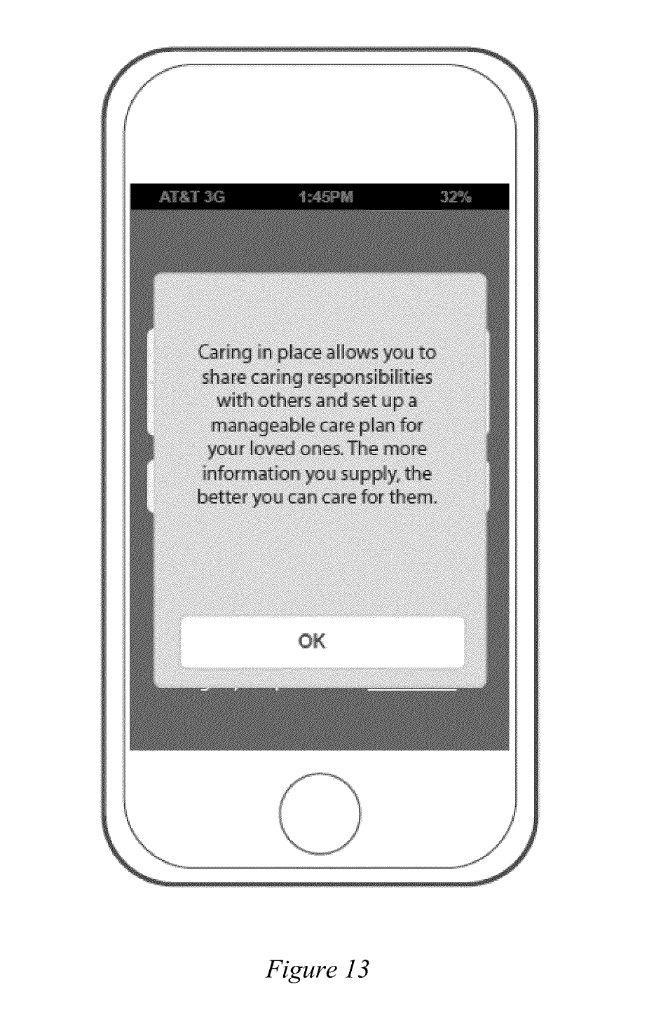

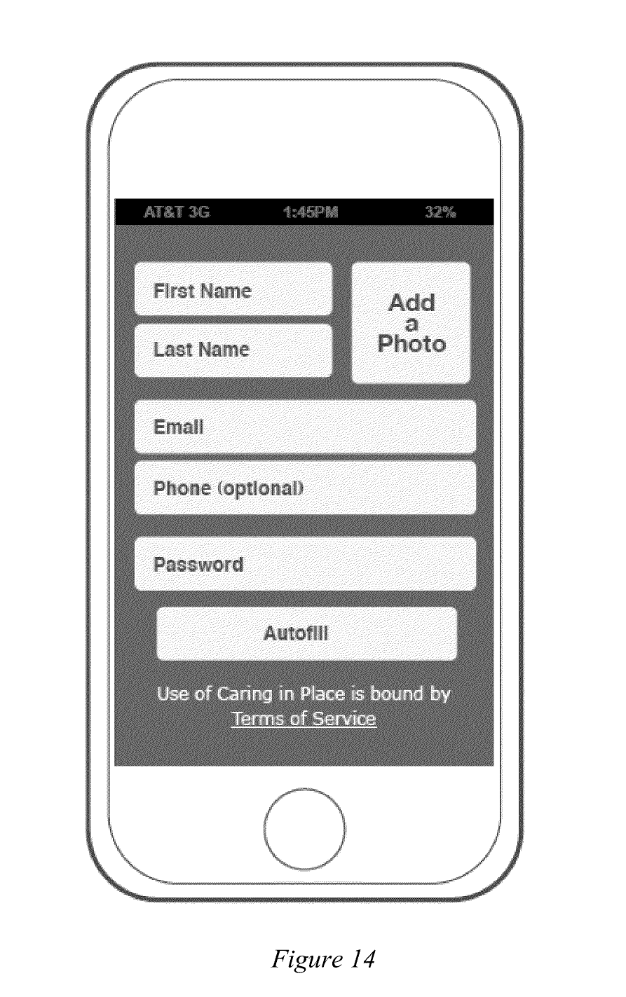

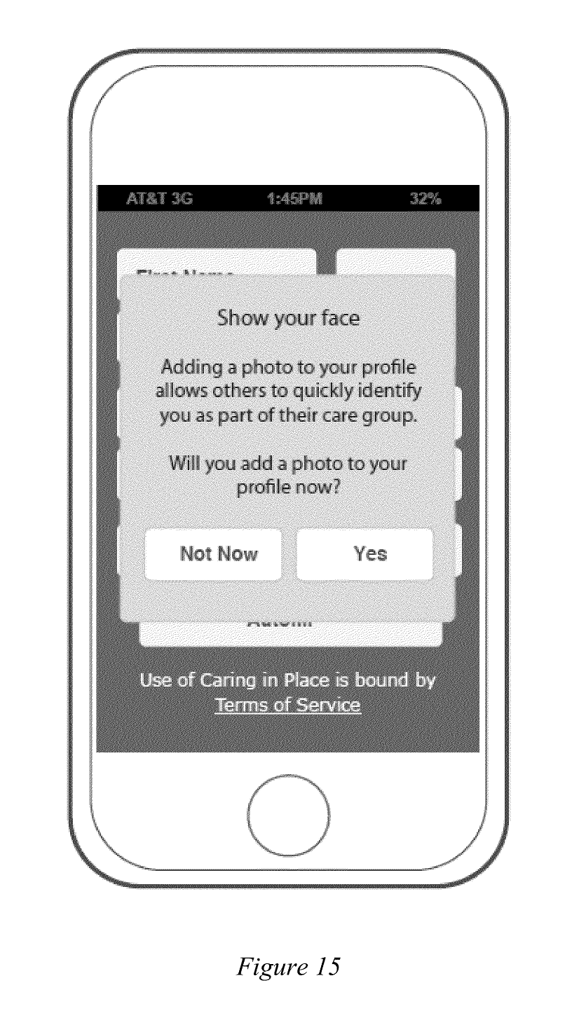

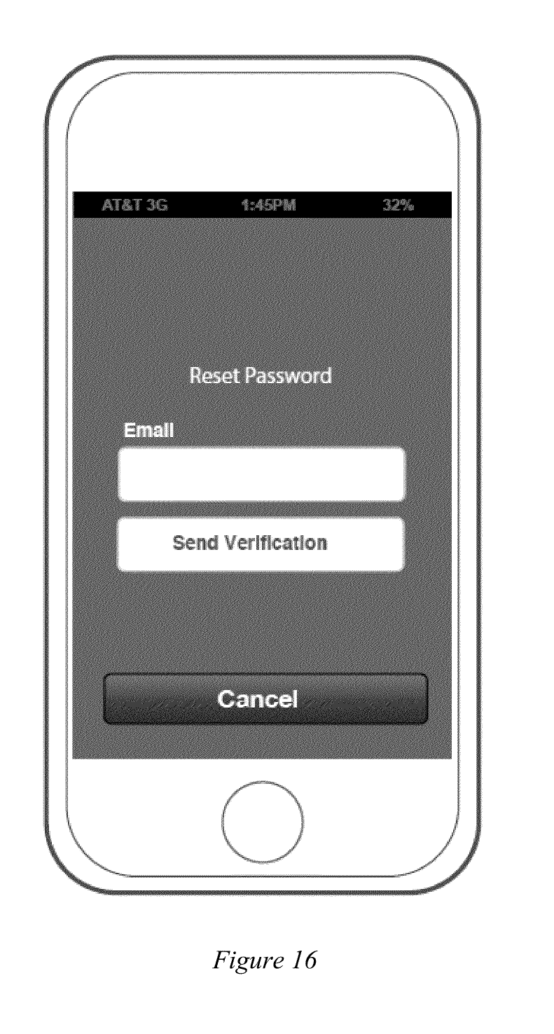

FIG. 12 shows a screenshot login screen that allows a caregiver to enter their username and password or to create account. FIG. 13 shows a screenshot of a notification reminding users to enter as much information as possible. FIG. 14 shows a screenshot that provides a user interface where the caregiver enters personal information about themselves. FIG. 15 shows a screenshot of a user interface asking the caregiver to add a photo of themselves. FIG. 16 shows a screenshot of system page that allows caregivers to change their password.

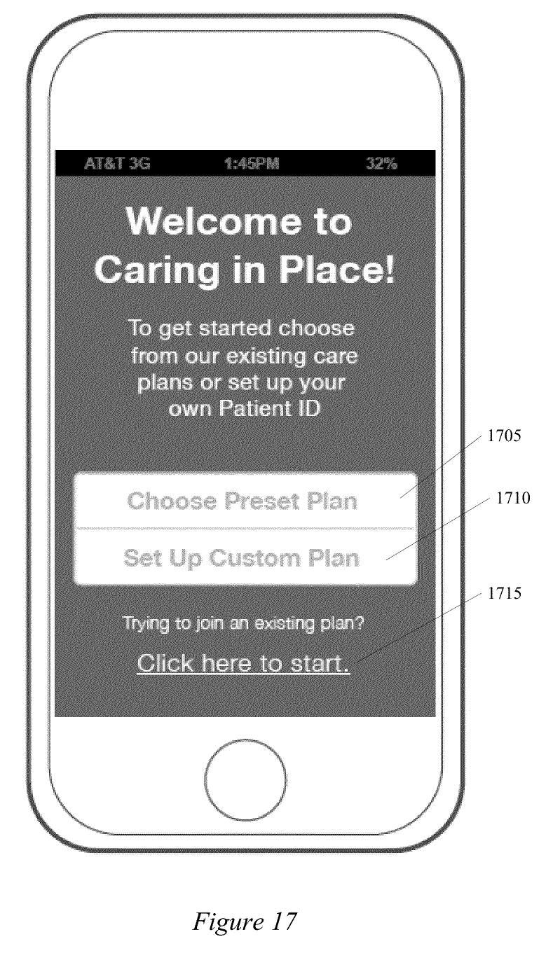

FIG. 17 shows a screenshot of a user interface that allows the caregiver to start a preset plan or a custom plan by selecting the “Choose a Preset Plan” button 1705 or the “Set Up Custom Plan” button 1710. A preset plan, for example, may be a plan that is developed for standard illnesses and/or diseases. A preset plan may also come from a third party or imported from another caregiver. A custom plan may provide more flexibility and can be modified to the needs of the care recipient. A caregiver may also join an existing plan by selecting the “Click here to Start” button or link 1715.

In some embodiments, a specific task can be shared with another caregiver without sharing the careplan. A task can be shared via email and/or text message. A task can be sent as a standard calendar reminder or task reminder (e.g., using MS Outlook standards, iPhone, or Goolge standards).

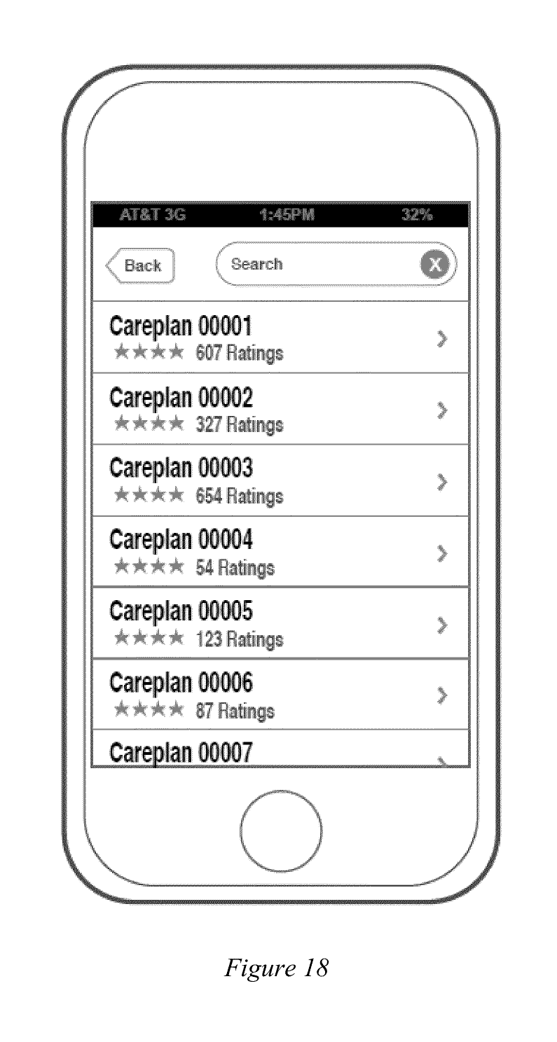

If the caregiver selects “Choose Preset Plan” button 1705, a series of preset plans are presented to the caregiver as shown in the screenshot shown in FIG. 18 according to some embodiments of the invention. These preset plans can be presented in various ways. For example, the preset plans can be presented in categories based on care recipient behaviors, diagnosis, ailments, symptoms, conditions, etc. Moreover, the preset plans can be presented with a description of the preset plan. Moreover, the listing of present plans can also include user ratings for the various plans. In some embodiments, preset plans can include custom plans created by other caregivers for other care recipients.

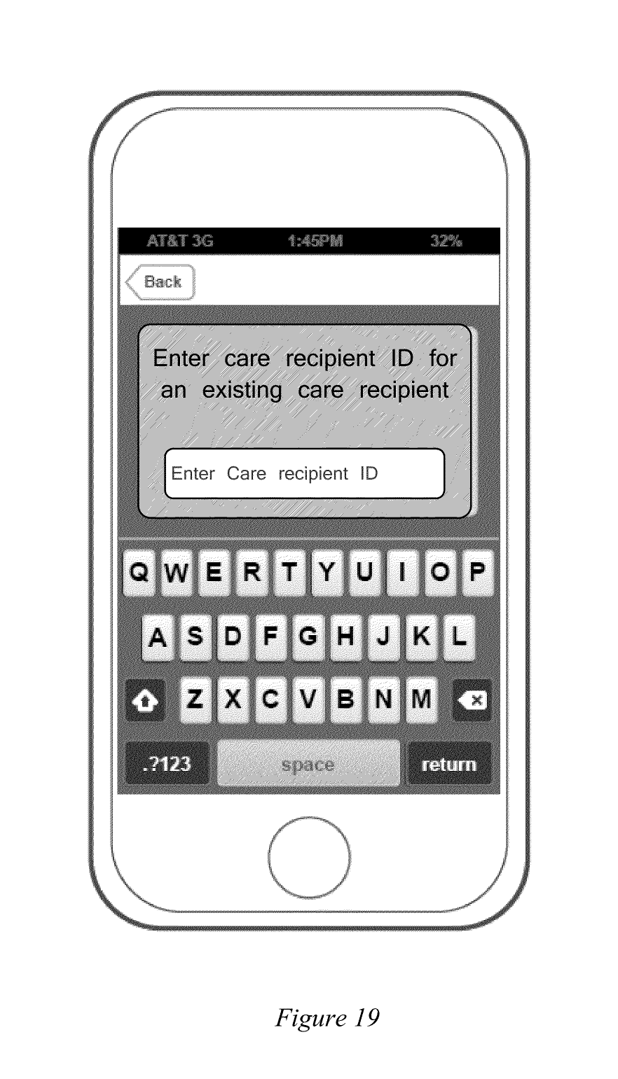

To select one of the preset plans, the caregiver selects one of the preset plans listed in FIG. 18. In some embodiments, after selecting a preset plan, in some embodiments the caregiver can be shown a summary of the preset plan. Once a preset plan is selected, the caregiver can be asked to enter the care recipient identifier for the care recipient they wish to provide a preset plan as shown in the screenshot in FIG. 19. In some embodiments, if the caregiver is associated with a single care recipient, then the caregiver may not be asked to enter the care recipient ID. In other embodiments, the caregiver can be presented with a drop down menu listing the names of the care recipients that they are associated with. The caregiver can then select one of the caregivers within the drop down menu. Various other ways may be used to allow the caregiver to select a care recipient.

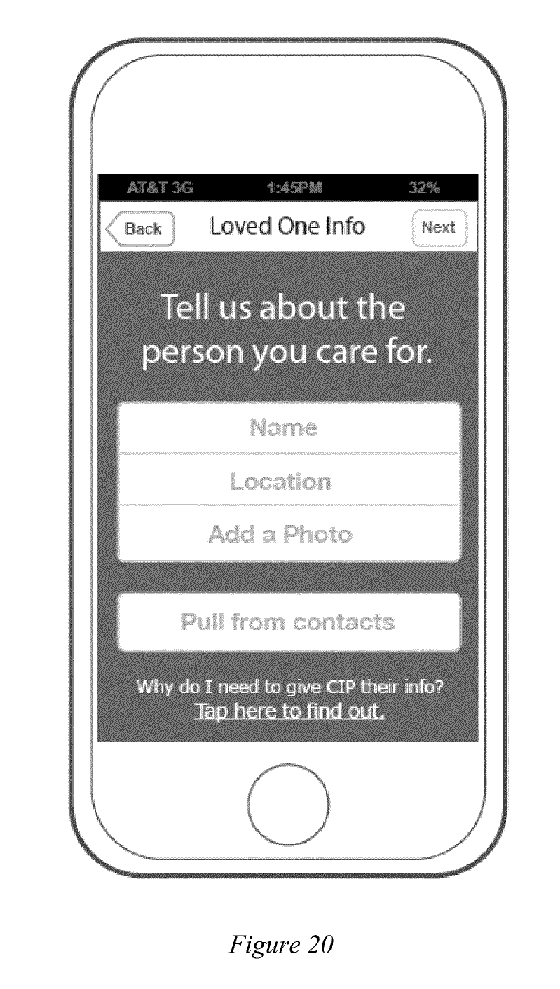

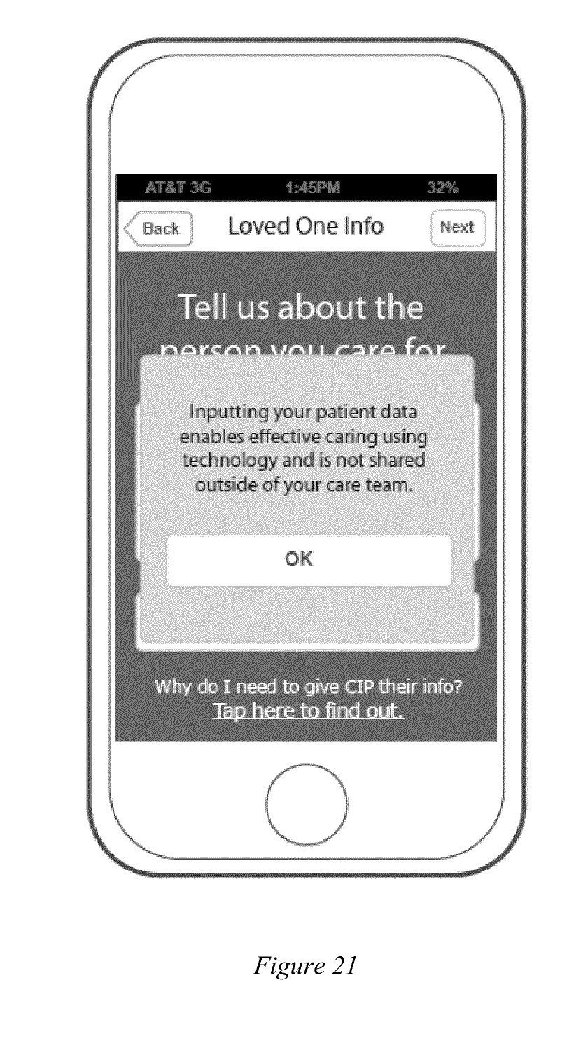

In some embodiments, information about care recipient can be requested as shown in the screenshot shown in FIG. 20 according to some embodiments of the invention. This information can be entered when setting up a care recipient in the care system. The requested information can include some or all the information listed in the care recipient ID structure. The care recipient's name and location can be entered. A photo may also be uploaded. In some embodiments, this information can be pulled in from the caregivers contact list listed on their device. If the caregiver is worried about entering information about the care recipient, they can select the link titled “Why do I need to give CiP their info?” In response, the caring in place application can respond as shown in the screenshot in FIG. 21.

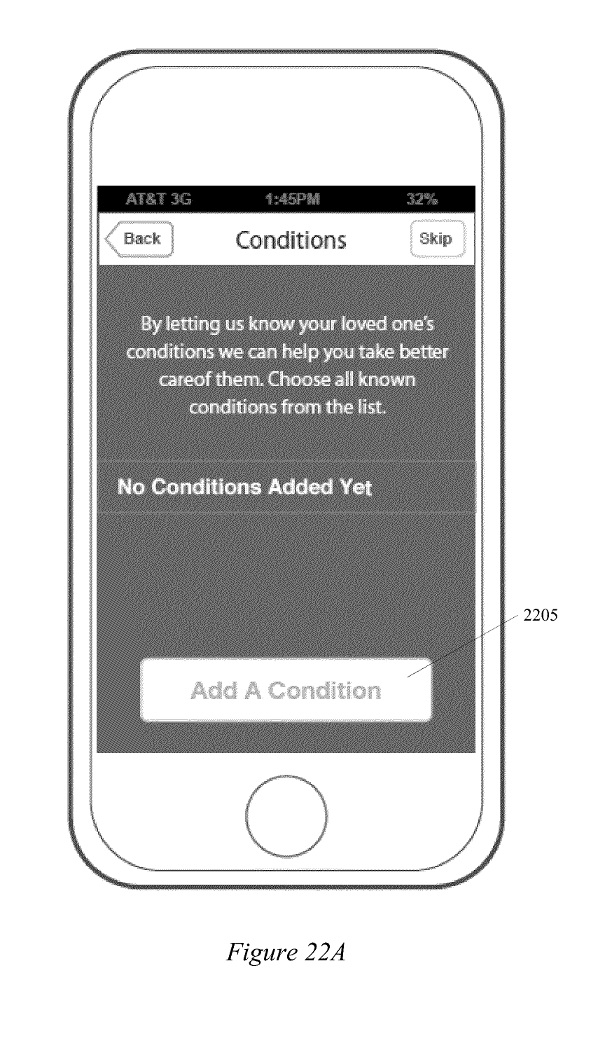

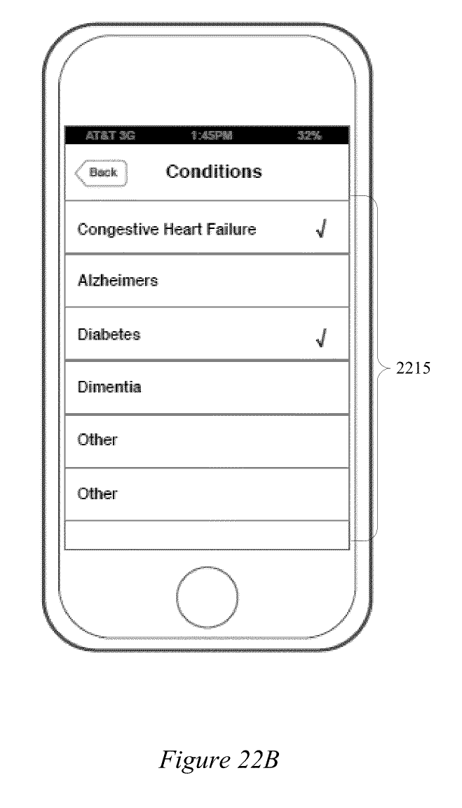

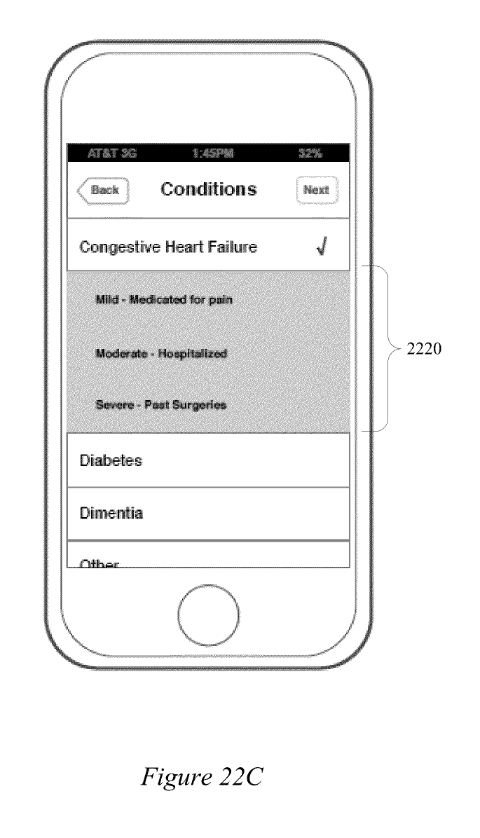

The screen shot shown in FIG. 22A the caregiver can enter conditions affecting that the care recipient. These conditions can be entered in text field 2205 as shown in FIG. 22A. In some embodiments, drop down menu 2215 can be presented with a listing of common conditions as shown in FIG. 22B. The severity of some conditions can be entered through drop down menu 2220 as shown in FIG. 22C.

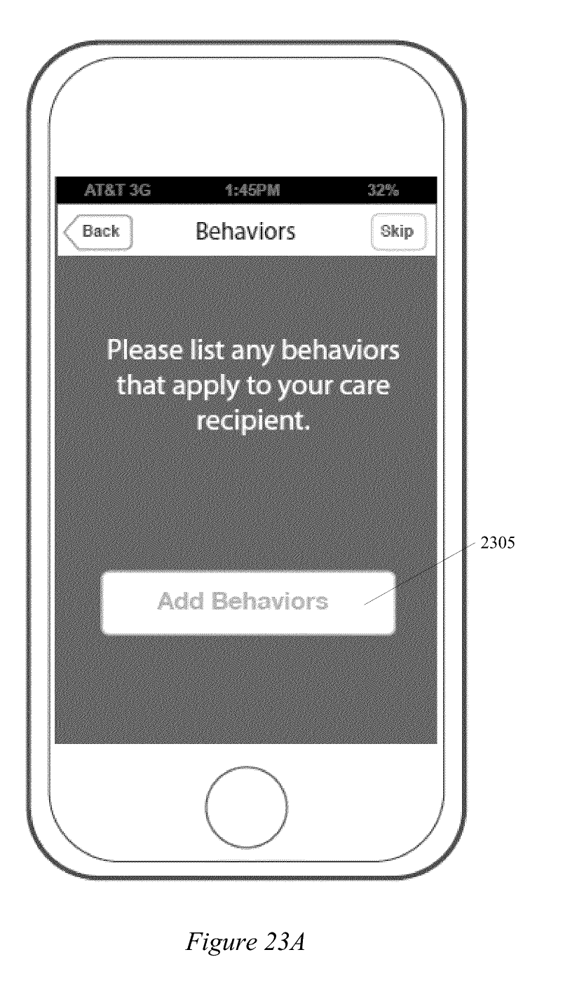

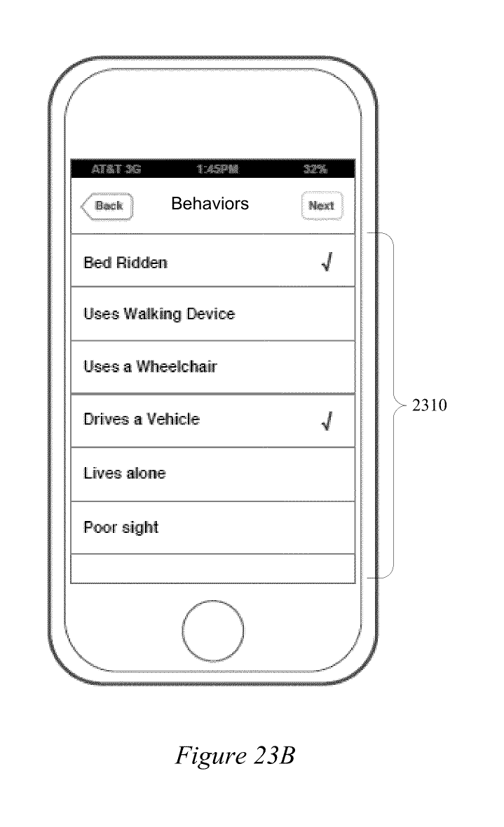

In FIG. 23A a screenshot is shown where the caregiver can enter behaviors associated with the care recipient. These behaviors can be entered in text field 2305 as shown in FIG. 23. In some embodiments, a drop down menu can be presented with a listing of common behaviors. In some embodiments, a drop down menu can be presented with a listing of common conditions as shown in FIG. 23B. The severity of a behavior can also be entered.

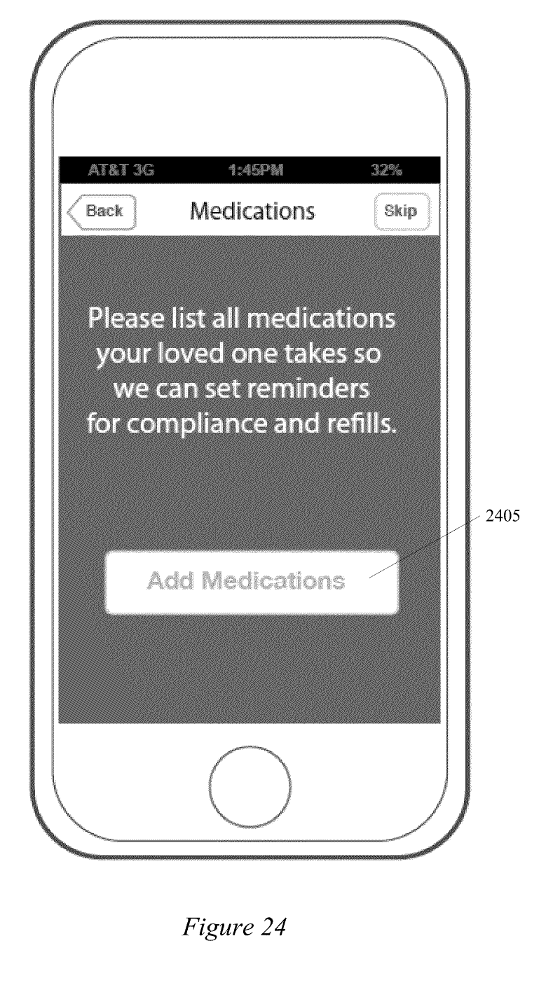

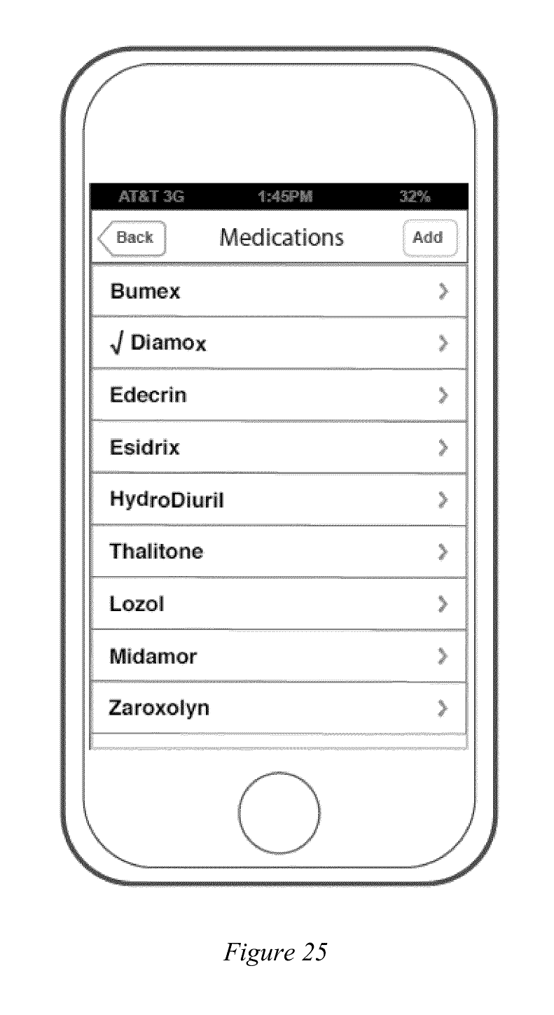

In the screen shot shown in FIG. 24 the caregiver can enter medication taken by the care recipient. Text field 2405 can be presented that allows a caregiver to enter other medications. A drop down menu can be provided listing common medications as shown in the screen shot shown in FIG. 25.

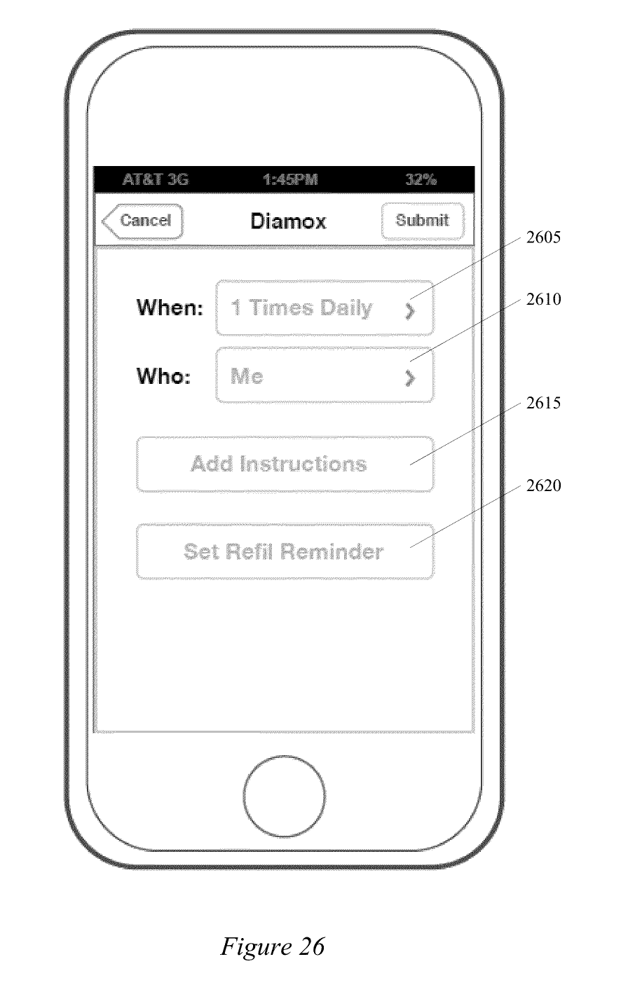

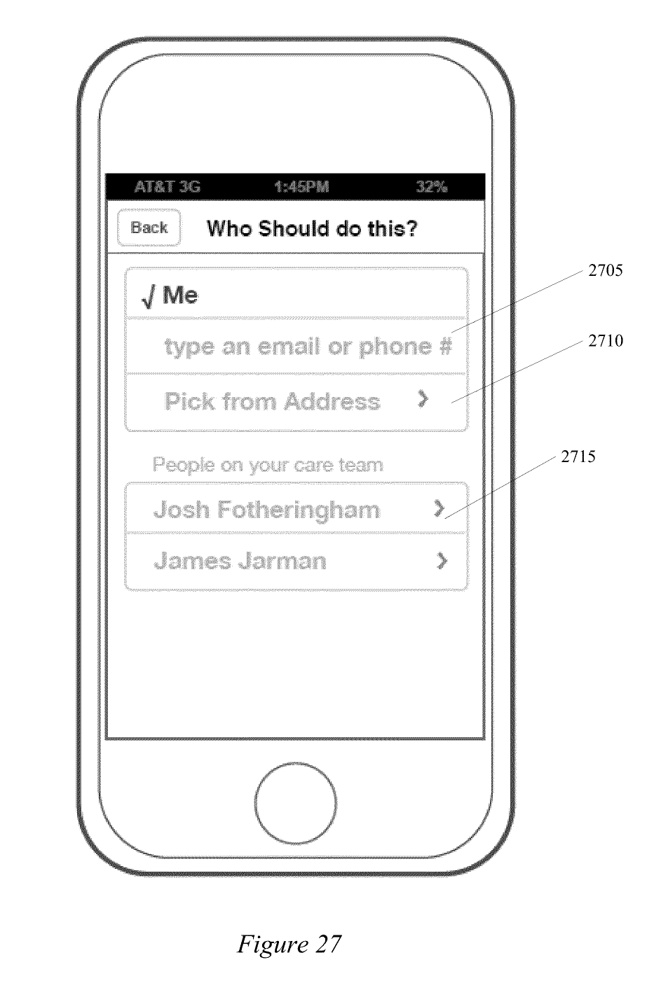

The screenshot shown in FIG. 26 shows an example of a user interface where the caregiver can enter the dosage amount and/or frequency of a given medication. For example, a drop down menu 2605 can be provided where the caregiver can enter when the medication should be taken. The caregiver may also assign responsibility for a specific medication to a caregiver using drop down menu 2610, input instructions associated with a medication using text filed 2615, and/or enter a refill reminder using text field 2620. FIG. 27 shows an example of a user interface where a caregiver assigns the task for refilling medication. Caregivers can be selected to perform this task from menu 2715. If the caregiver's email and/or phone number is not in the system one can be entered in text box 2705. The address for the pharmacy where the refill can be picked up can be entered in filed 2710.

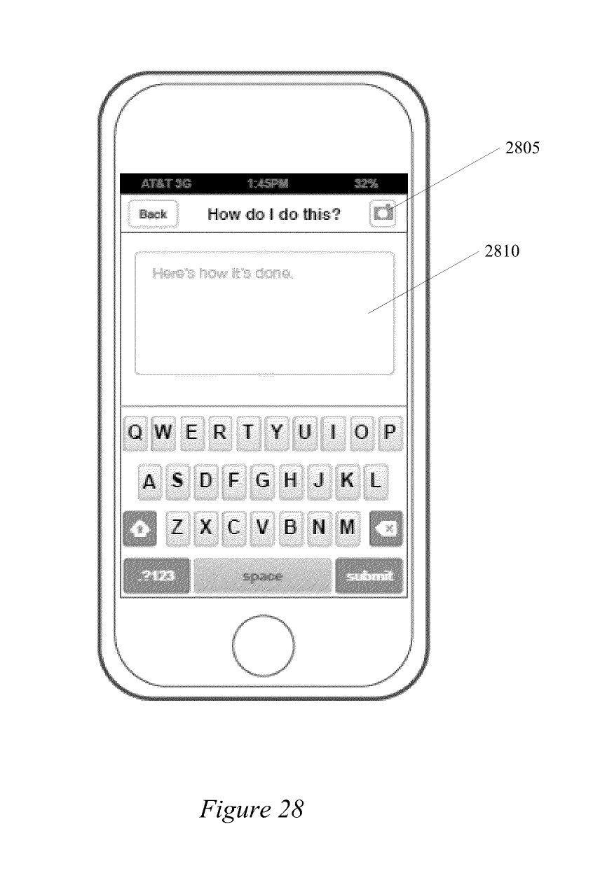

The screenshot shown in FIG. 28 shows an example of a user interface where the caregiver can enter instructions for a given task, such as helping with medication. The caregiver can be directed to this screen, for example, by selecting button 2615 in FIG. 26. The caregiver can enter notes in text entry field 2810 and/or use a camera associated with their smartphone to take a picture of, record a video showing, or record audio about how to do this by selecting the phone button 2805.

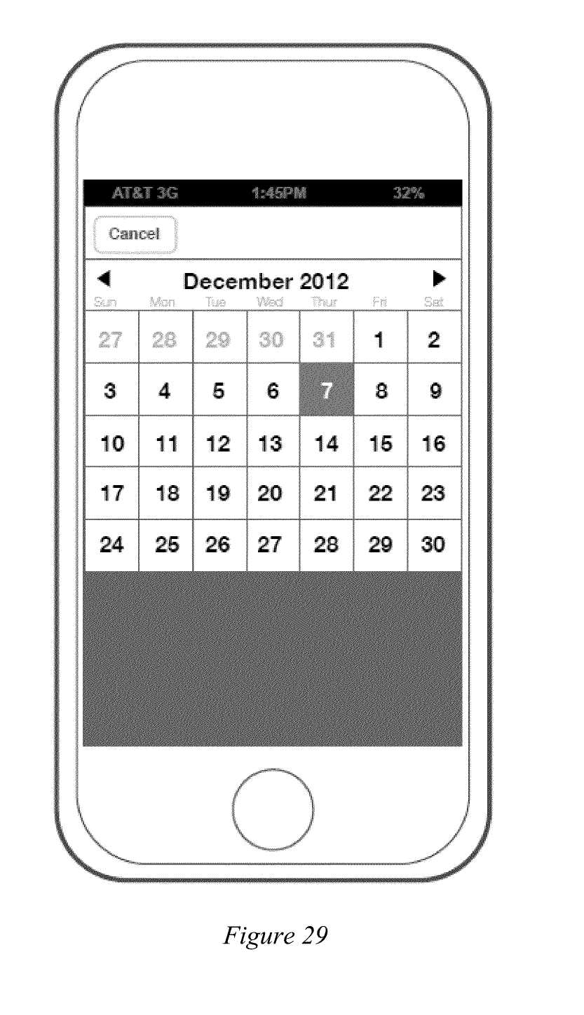

The screenshot shown in FIG. 29 shows an example of a user interface selecting a refill reminder date. The selected date can then be used by the system to create a task to be included in the Care Plan. The task, for example, can have a task name of Refill<care recipient's name> and <insert medication name> prescription. Task details can also be system generated and can be simple instructions associated with when and how the refill should occur.

The screenshot shown in FIG. 29 could also be used as an example of a user interface selecting a date when a task should be accomplished. For example, the date can coincide when medication should be taken, when the care recipient should be taken to a doctor, when a medication should be refilled, etc.

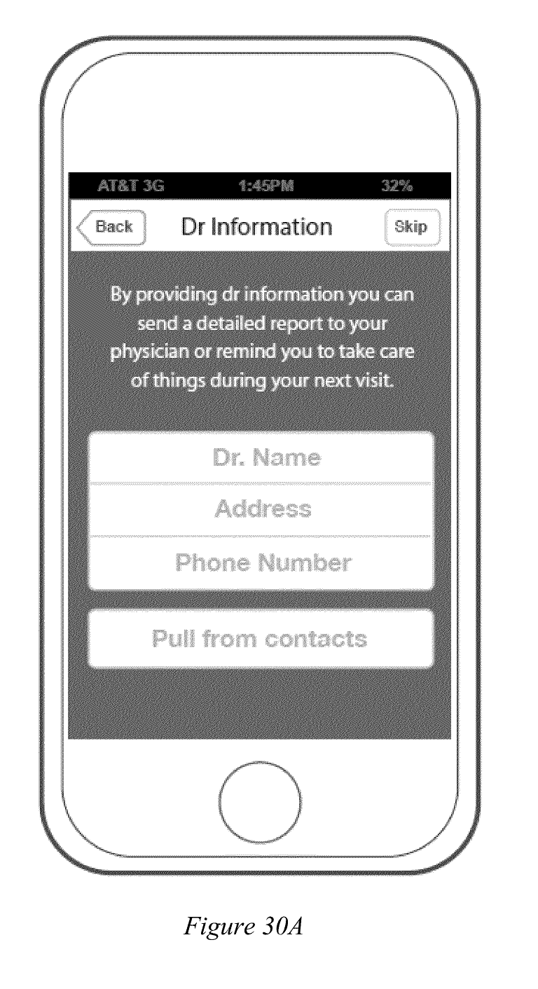

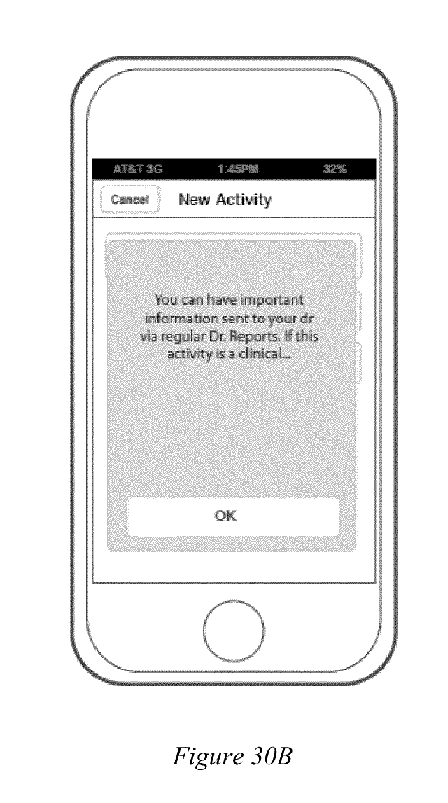

The screenshot shown in FIG. 30A shows an example of a user interface entering doctor information. The doctor information can be pulled from the caregiver's contacts and/or the information can be manually entered. The screenshot shown in FIG. 30B shows an example of a user interface for entering automatic reporting to a doctor or medical office.

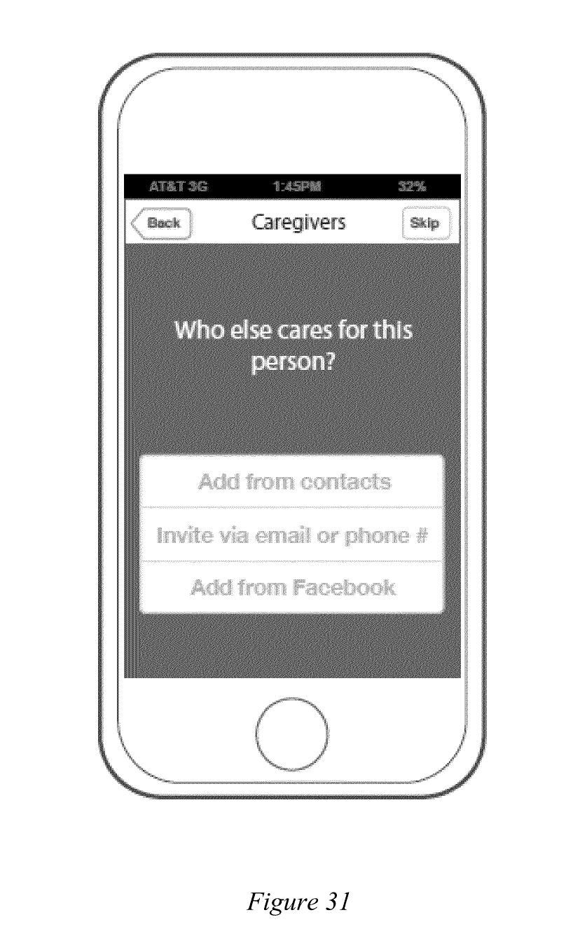

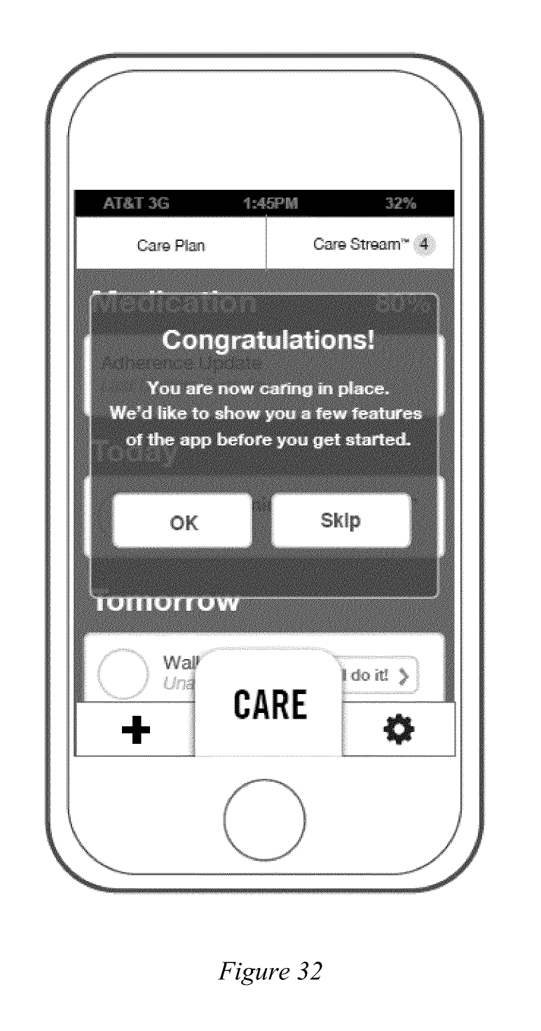

The screenshot shown in FIG. 31 shows an example of a user interface that can be used by a primary caregiver to enter information for a co-caregiver. Information can be pulled from the primary caregiver's contacts and/or manually entered. Once information about the caregivers and the care recipient has been entered, caring in place can begin as shown in the screenshot shown in FIG. 32. FIG. 32 also is an example of a feature demo that highlights available functionality within the application or web portal.

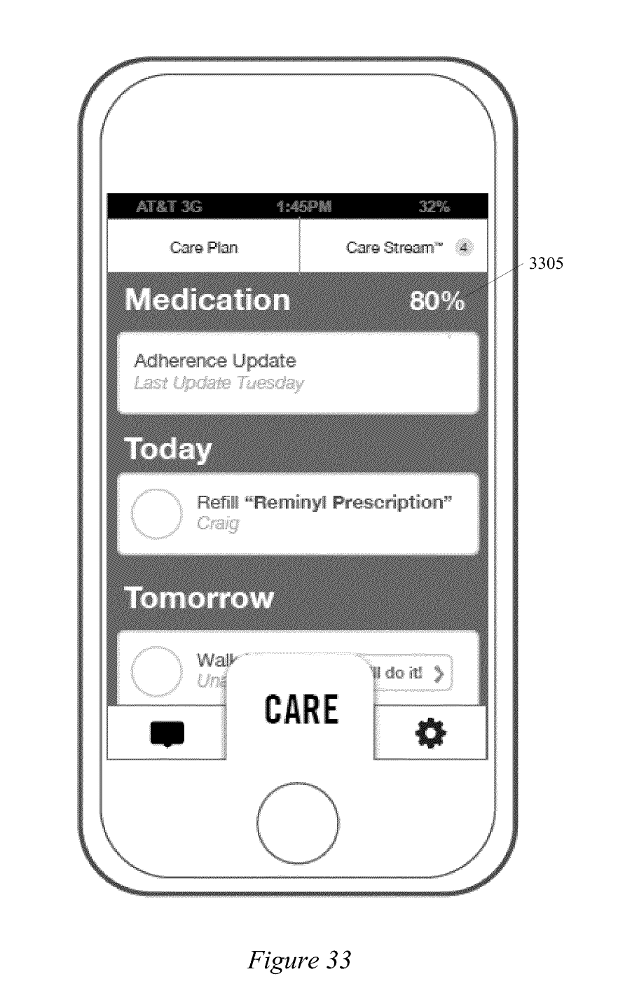

The screenshot shown in FIG. 33 shows an example of a user interface listing various tasks required for caregivers to perform in order to care for a care recipient. Also shown is a medication compliance score 3305.

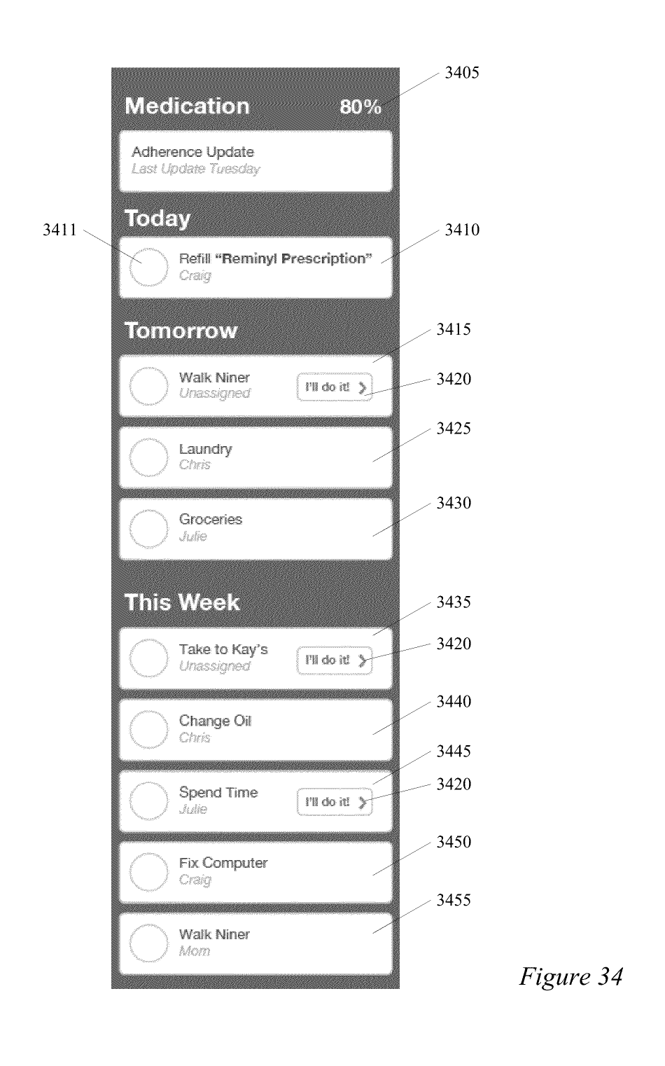

FIG. 34 shows an example of an extend list of some tasks along with compliance update 3405. Today's task includes refilling a Reminyl prescription 3410. The task includes the name of the caregiver, Craig, which has volunteered to complete the task. Button 3411 is selectable to confirm when a task has been accomplished. Tomorrow's tasks include Walk the dog, Niner, 3415, do the laundry 3420, and buy groceries 3430. Note that the walk the dog task 3415 is unassigned. A caregiver can select button 3425 to volunteer to do the task. The list also includes tasks to complete later in the week including Take the care recipient to Kay's 3420, change the oil in the car 3440, spend time with the care recipient 3445, fix the care recipient's computer 3450, and walk Niner again 3455. Various other tasks can be created without limitation.

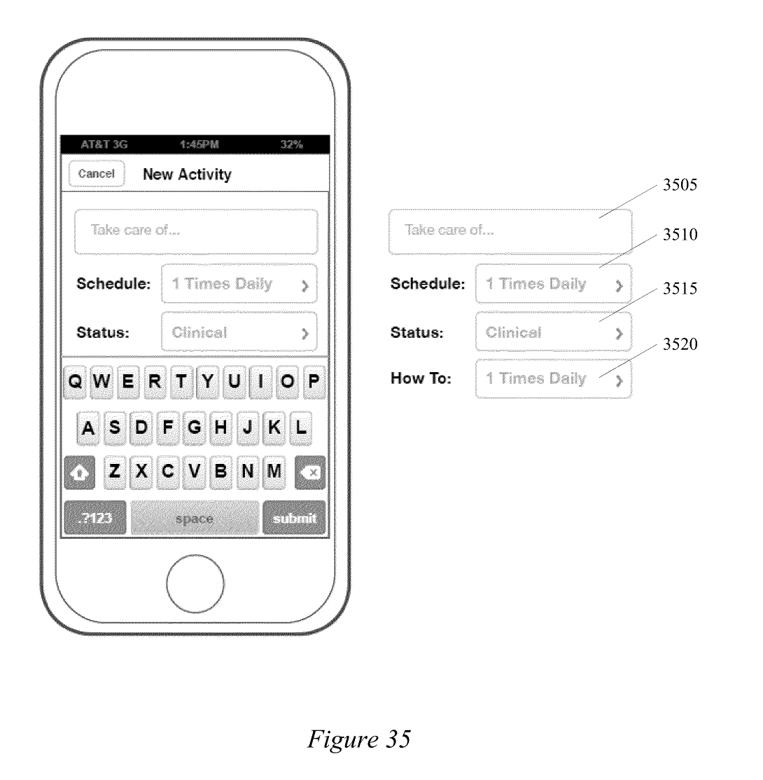

The screenshot shown in FIG. 35 shows an example of a user interface that can be used to create a new task (or activity). Text box 3505 can be used to add the task name or title. Drop down menu 3510 can be used to schedule the frequency of the task. Drop down menu 3515 can be used to note the status of the task. That is, clinical vs. non-clinical. Drop down menu 3520 can be used to enter the number of times per day the task should be accomplished.

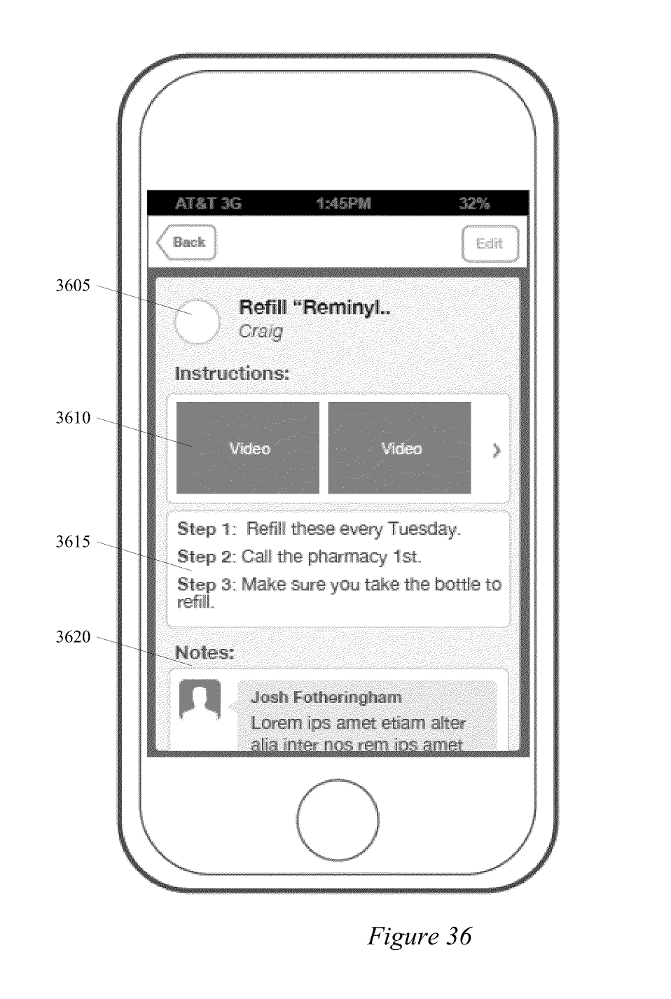

The screenshot shown in FIG. 36 shows an example of a user interface that can be used for a single task according to some embodiments of the invention. For example, if a caregiver selects on a task using their smartphone or tablet, the user can view media 3610 showing the user how to complete the task and/or steps to take to complete the task 3615. A note section 3620 can allow caregivers to write notes about the task. Completion button 3605 can be selected by a caregiver to indicate completion of the task.

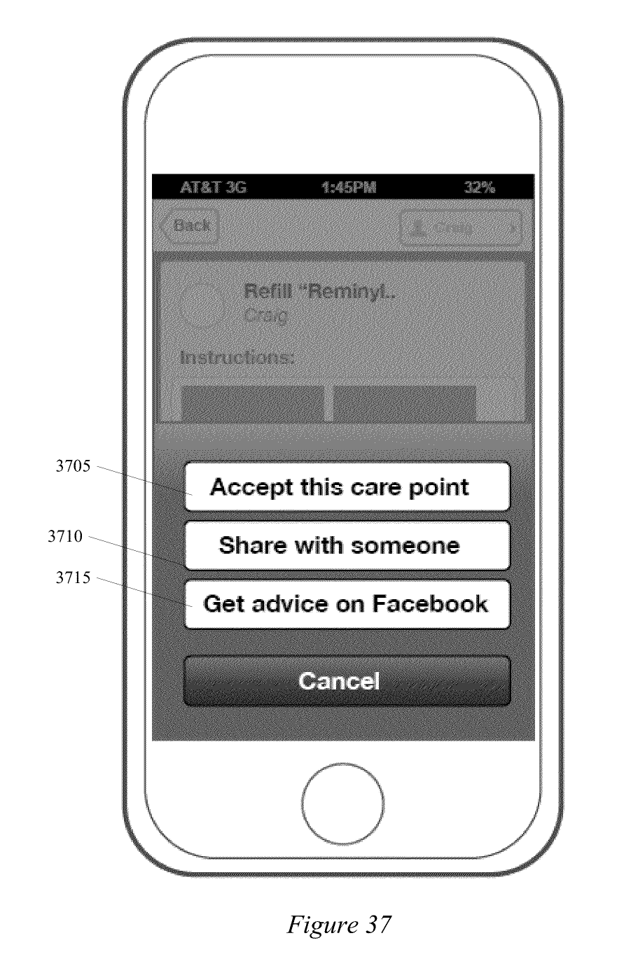

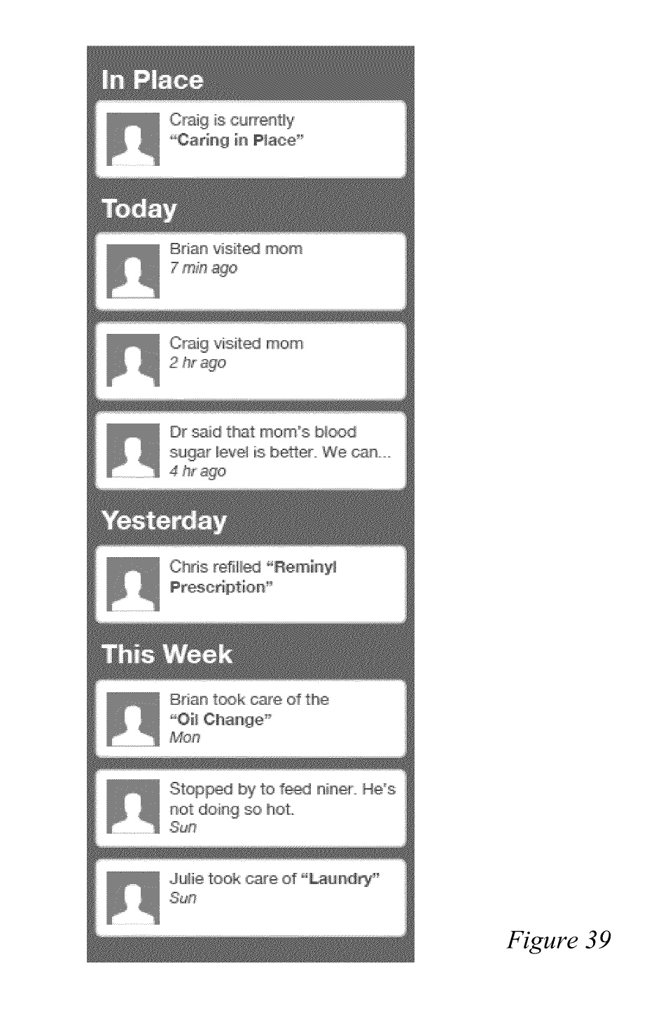

The screenshot shown in FIG. 39 shows an example of a user interface that can be used to provide a number of options related to a specific task. For example, inside the Task Details screen a Task Options button may be included that when selected shows the three options shown on FIG. 37. The user can assign or reassign the task to themselves by selecting button 3705, push the task to someone else to see if they will accept it (done through the Care Stream wall posting) by selecting button 3710, or post the task name (with a link to Task Details) to their Facebook wall to solicit advice from others by selecting button 3715. Other options may be included with other buttons. This may also enable caregivers to post to a forum of similarly challenged caregivers who are all part of a collective Facebook group.

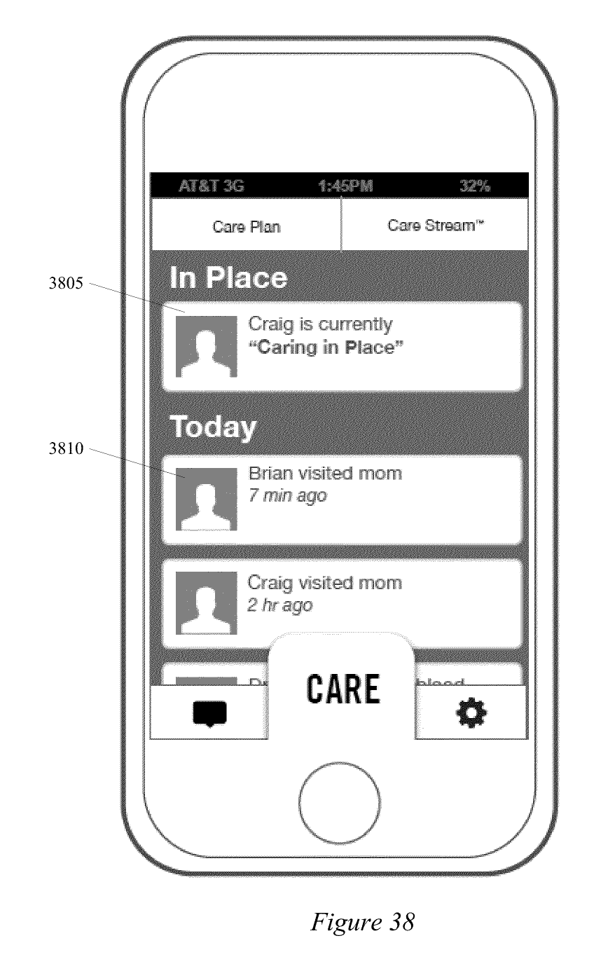

The screenshot shown in FIG. 38 shows an example of a user interface that can be used to show tasks completed and/or whether a caregiver is near the care recipient. FIG. 39 shows an example of an extended list of completed tasks and/or nearby caregivers that a caregiver can scroll through on their computing device. For example, the current screen shot shows that Craig is on location with the recipient or “caring in place” 3805, and shows what Brian and Craig did earlier in the day.

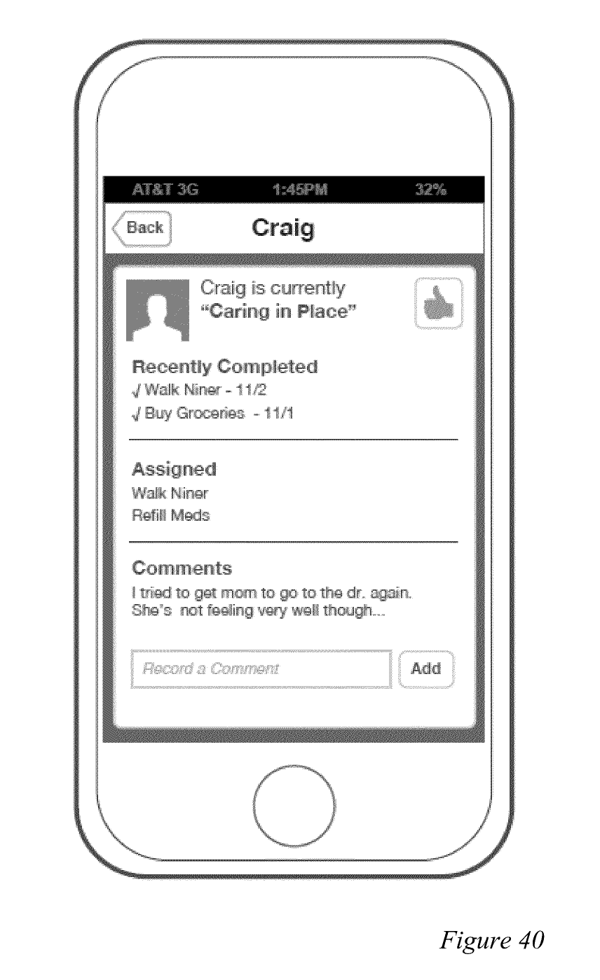

The screenshot shown in FIG. 40 shows an example of a user interface that can be used to display a caregiver's profile. The Caregiver's profile can include the caregiver's information, where the caregiver is relative to the care recipient (e.g., on location), one or more recently completed tasks, assigned tasks, and/or comments provided by the caregiver.

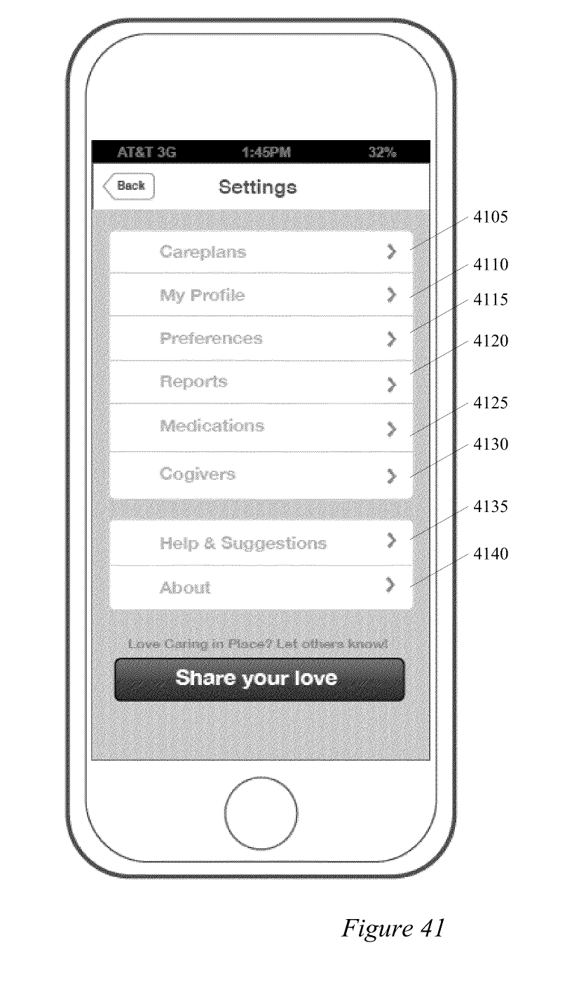

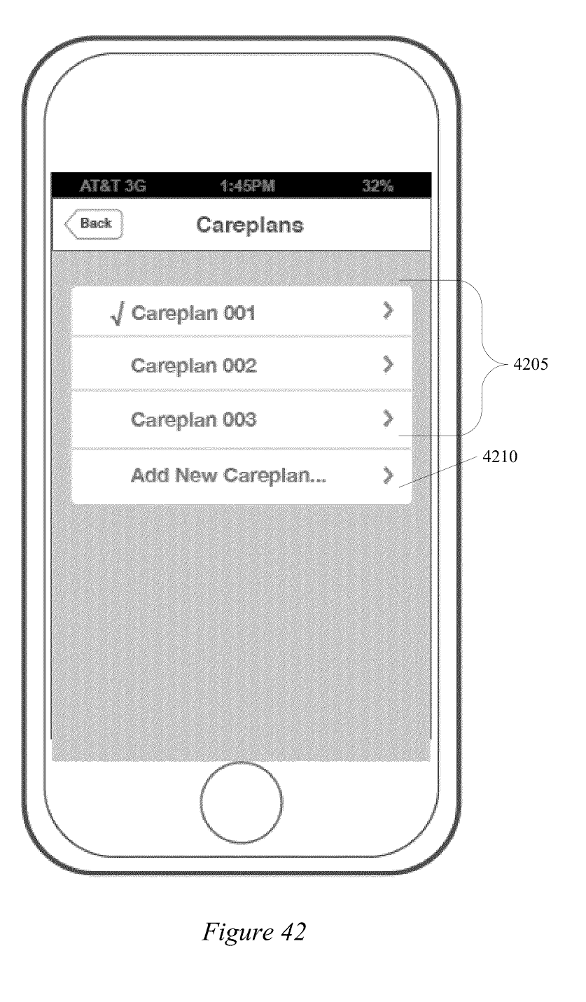

The screenshot shown in FIG. 41 shows an example of a user interface that can be used to display settings related to the caregiver, care recipients, and/or careplans. For example, a caregiver can look up all the careplans that that they are participating in by selecting the careplans button 4105 (see FIG. 42). A caregiver may also switch between multiple care plans that they may be managing (e.g., one for mom and one for dad) by selecting the appropriate careplan button 4205. They can create a new Care Plan too (entering a new patient ID or starting a new plan from scratch) by selecting button 4210.

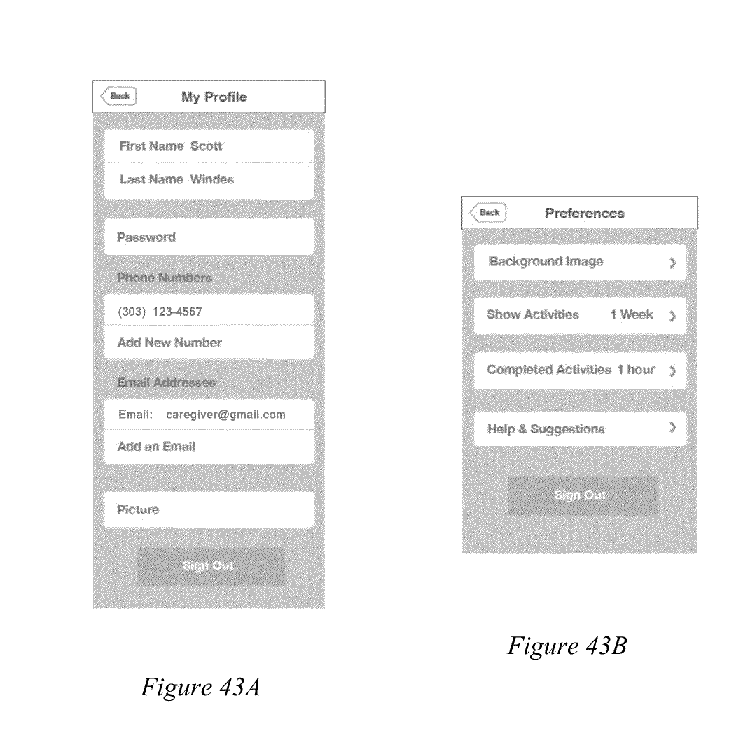

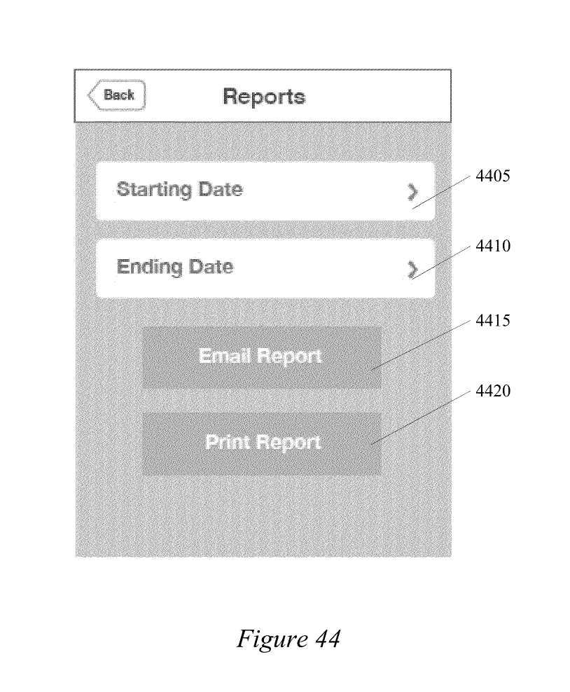

A caregiver can look up and/or modify their profile by selecting My Profile button 4110 (See FIG. 43A). A caregiver can look up and/or change their user preferences by selecting the Preferences button 4115 (See FIG. 43B). Reports about a care recipient can be generated by selecting the Reports button 4120 (See FIG. 44). A doctor report summarize and/or compile information and/or statistics collected by the caregiver(s), home healthcare provider, or at home device and organized in a way that is meaningful to the doctor. In some embodiments the information included in a report can be information flagged to be included within a doctor report. A listing of medications being used by the care recipients being cared for can be listed by selecting the Medications button 4125. Information about co-caregivers can also be looked up by selecting the co-caregivers button 4130.

The screenshot shown in FIG. 42 shows an example of a user interface that can be used to view the careplans currently used by a caregiver to care for a care recipient. One or more careplans can be listed. A caregiver can select a careplans to view the details of the careplans.

The screenshot shown in FIG. 43A shows an example of a user interface that can be used to display a caregiver's profile. The screenshot shown in FIG. 43B shows an example of a user interface that can be used to display caregiver preferences. The caregiver can set the time period to view prospective and/or completed activities. Various other preferences can be shown.

The screenshot shown in FIG. 44 shows an example of a user interface that can be used to generate reports. A caregiver can select the starting date 4405 and the ending date 4410 of the report. A report can be automatically generated that shows all the care related activities and/or tasks that were completed during these time periods. The report can include clinical information as well including ailments, diagnosis, symptoms and/or medications taken. The generated report can be emailed to a recipient by selecting the email report button 4415 and/or printed by selecting the print report button 4420.

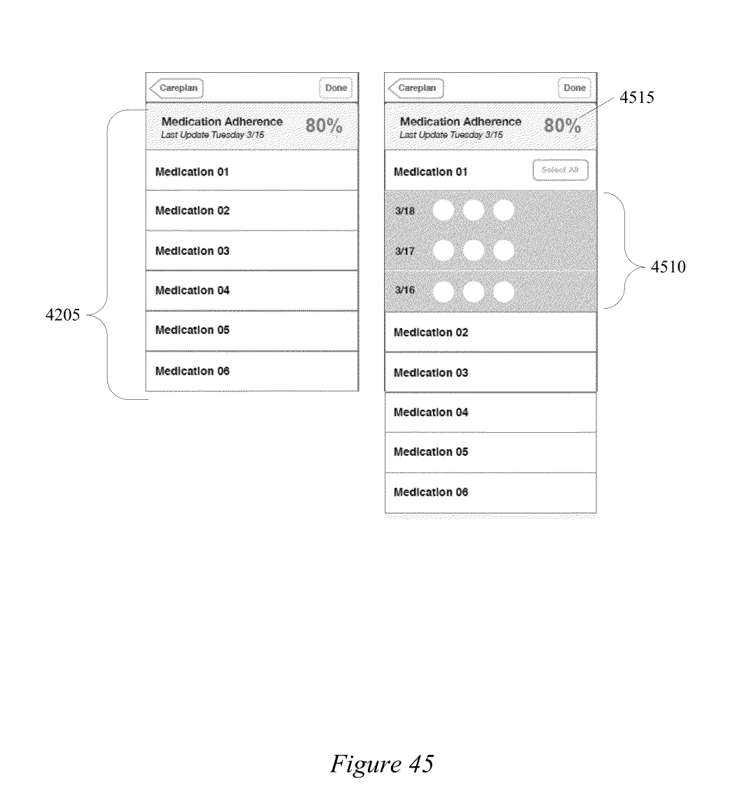

The screenshot shown in FIG. 45 shows an example of a user interface that can be used to enter medication compliance. The medications taken by the care recipient can be listed in listing 4505. A caregiver can select one medication and enter data indicating whether the care recipient took the medication on the required days in the required dosage based on the medication dosage information previously entered (see FIG. 26). As shown, data entry field 4510 can be provided that allows a caregiver to indicate compliance with medication administration. Based on the received information, a medication compliance score 4515 can be generated that indicates the percentage of compliance. That is the number of times medication was taken versus the number of times the medication was required.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A system for coordinating care for a care recipient by one or more caregivers, the system comprising:
one or more caregiver devices that are each used by an individual caregiver; and
a care server communicatively coupled with the one or more caregiver devices in use by a caregiver, wherein the care server is configured to:
generate one or more care related tasks for a care recipient, wherein the care recipient is different from any of the care givers,
assign each of the one or more tasks to individual caregivers, and
communicate the tasks to the caregivers via the caregiver device.

2. The system according to claim 1, wherein the care server is further configured to receive data from one of the caregivers via one of the caregiver devices specifying a health conditions of the care recipient, and wherein the generated one or more care related tasks are related to the health condition.

3. The system according to claim 1, wherein the care server is further configured to receive data from one of the caregivers via one of the caregiver devices defining the task.

4. The system according to claim 1, wherein the care server is further configured to receive data from one of the caregivers via one of the caregiver devices specifying completion of a task and sending data to the caregivers via the caregiver devices indicating completion of the task.

5. The system according to claim 4, wherein the care server is further configured to receive a request for a report indicating the completion of care related tasks, and is further configured to generate the report.

6. The system according to claim 1, wherein the care server is further configured to receive data from one of the caregivers via one of the caregiver devices indicating a specific caregiver should be assigned to a specific task.

7. The system according to claim 1, wherein one of the one or more tasks is related to a product or service, and wherein the care server is further configured to offer the product or service to one of the caregivers.

8. A method comprising:
receiving data from a caregiver via a caregiver device indicating a medication dosage for a care recipient, wherein the care recipient is different from the caregiver;
pushing reminders to one or more caregivers through the caregiver device reminding the caregiver to check on the care recipient's adherence to the medication dosage;
receiving input from a caregiver indicating dates, times and amounts of medication taken by the care recipient; and
determining a medication adherence measure based on the medication dosage and on the input indicating dates, times and amounts of medication taken.

9. The method according to claim 8, wherein the medication dosage includes dosage for a plurality of medications, and the medication adherence measure is based on adherence to the plurality of medications.

10. The method according to claim 8, wherein the adherence measure is pushed to one or more caregivers.

11. The method according to claim 8, further comprising:
receiving a request from a caregiver via a caregiver device for a report including the medication adherence measure; and
creating a report that includes the medication adherence measure.

12. The method according to claim 11, wherein the request for a report indicates one of an email address or a fax number, and wherein the report is emailed or faxed to the email address or the fax number.

13. A method comprising:
receiving at a care server from a caregiver information about a care recipient, the information including a health condition of the care recipient;
saving the information about the care recipient into a database;
receiving at the care server from a caregiver information about a plurality of tasks related to the care of the care recipient;
saving the information about the plurality of tasks into the database;
receiving at the care server from a caregiver information about one or more co-caregivers;
saving the information about the plurality of tasks into the database;
creating a care plan at the care server that assigns at least one of the tasks to a specific caregiver; and
indicating in the database that the at least one task is associated with the specific caregiver.

14. The method according to claim 13, further comprising receiving an indication at the care server that a task has been completed and indicating in the database that the task has been completed.

15. The method according to claim 14, further comprising receiving a request from a caregiver for a report; and producing a report from the data in the database specifying the details of completed tasks.

16. The method according to claim 13, further comprising receiving a message from a caregiver requesting assignment of an unassigned task and indicating in the database that the task is associated with the caregiver.

17. The method according to claim 13, further comprising sending information about the care plan to one or more caregivers.
